(19) United States
(12) Patent Application Publication
(10) Pub. No.: US 2011/0191202 A1
(43) Pub. Date: Aug. 4, 2011

(54) Method, apparatus and system for bidding custom parts

(75) Inventor: David Michael Keicher, Albuquerque, NM (US)

(73) Assignee: LOCAL MANUFACTURING, LLC, Albuquerque, NM (US)

(21) Appl. No.: 12/931,391

(22) Filed: Jan. 31, 2011

Related U.S. Application Data
(60) Provisional application No. 61/337,195, filed on Feb. 1, 2010.

(51) Int. Cl. G06Q 30/00

(52) U.S. Cl. 705/26.3

(57) ABSTRACT

A method that includes: generating a request for quote for a custom part via a computer network system; receiving one or more bids for the request for quote via a computer network system; and accepting and paying an invoice for a bid acceptance via a computer network system.

### CROSS-REFERENCE TO RELATED APPLICATION(S)

This application claims the benefit of U.S. Provisional Patent Application Ser. No. 61/337,195 filed Feb. 1, 2010, and the subject matter thereof is incorporated herein by reference thereto.

### TECHNICAL FIELD

The present invention relates generally to a method, apparatus and system for bid requests, and more particularly to a method, apparatus and system for blind bidding build-to-order parts via a network communication system.

### BACKGROUND ART

Many businesses require build-to-order or manufactured parts and do not possess the ability to produce such products themselves. Unfortunately, traditional means to receive quotes and place orders for these products do not permit these businesses a timely and efficient mechanism for receiving bids on their requests for a build-to-order or manufactured part.

Thus, a need still remains for a method, apparatus and system that permit a customer to seek multiple bids from vendors for build-to-order or manufactured parts.

### DISCLOSURE OF THE INVENTION

The present disclosure provides a method that includes: generating a request for quote for a custom part via a computer network system; receiving one or more bids for the request for quote via a computer network system; and accepting and paying an invoice for a bid acceptance via a computer network system.

The present disclosure provides a method that includes: receiving a request for quote for a custom part via a computer network system; generating one or more bids for the request for quote via a computer network system; and generating an invoice for a bid acceptance via a computer network system.

The present disclosure provides a method that includes: receiving a request for quote for a custom part via a computer network system; generating one or more bids for the request for quote via a computer network system; and communicating completion and acceptance of custom part via a computer network system.

The present disclosure provides an apparatus that includes: a user interface for a computer network system; and a software interface including instructions executed by a computer for processing bids from a plurality of service providers.

The present disclosure provides an apparatus that includes: a computer network system and connection; a memory device; a processor; and a user interface operated on the computer network system, the user interface including computer readable instructions for processing bids from a plurality of service providers.

Additional features and aspects of the disclosure and/or invention will become apparent to those skilled in the art from a reading of the detailed description, taken in conjunction with and reference to the accompanying drawings.

### BRIEF DESCRIPTION OF THE DRAWINGS

The foregoing and other advantages and features of the invention will become more apparent from the detailed description of the preferred embodiments given below with reference to the accompanying drawings.

FIG. 1 is an exemplary diagram depicting the physical structure of a computer system in accordance with an embodiment of the present invention.

FIG. 2 is a general architecture of an exemplary network communication system in accordance with an embodiment of the present invention.

FIG. 3 is a flow chart depicting an exemplary process for a request for bid for a build-to-order part in an embodiment of the present invention.

FIG. 4 is a flow chart depicting an exemplary process for a request for bid for a build-to-order part in another embodiment of the present invention.

FIG. 5 is a screenshot of an exemplary web page depicting a “Home Page” of a website in accordance with an embodiment of the present invention.

FIG. 6 is a screenshot of an exemplary web page depicting a website including a Customer page for “Create Project” in accordance with an embodiment of the present invention.

FIG. 7 is a screenshot of an exemplary web page depicting a website including a Customer page in Manage Account for “Edit Info” in accordance with an embodiment of the present invention.

FIG. 8 is a screenshot of an exemplary web page depicting a website including a Customer page in Manage Account for “Deposit Funds” in accordance with an embodiment of the present invention.

FIG. 9 is a screenshot of an exemplary web page depicting a website including a Customer page in Manage Account for “Transfer Funds” in accordance with an embodiment of the present invention.

FIG. 10 is a screenshot of an exemplary web page depicting a website including a Customer page in Manage Account for “Submit Purchase Order” in accordance with an embodiment of the present invention.

FIG. 11 is a screenshot of an exemplary web page depicting a website including a Customer page in Manage Account for “Withdraw Funds” in accordance with an embodiment of the present invention.

FIG. 12 is a screenshot of an exemplary web page depicting a website including a Customer page in Manage Account for “Escrow Payment” in accordance with an embodiment of the present invention.

FIG. 13 is a screenshot of an exemplary web page depicting a website including a Customer page in Manage Account for “Account Balance” in accordance with an embodiment of the present invention.

FIG. 14 is a screenshot of an exemplary web page depicting a website including a Customer page in Manage Account for the “View All” button in Account Balance in accordance with an embodiment of the present invention.

FIG. 15 is a screenshot of an exemplary web page depicting a website including a Customer page under Manage Projects in accordance with an embodiment of the present invention.

FIG. 16 is a screenshot of an exemplary web page depicting a website including a Customer page in Manage Projects for “Pending Approval List” in accordance with an embodiment of the present invention.

FIG. 17 is a screenshot of an exemplary web page depicting a website including a Customer page in Manage Projects for “Rate Vendor” in accordance with an embodiment of the present invention.

FIG. 18 is a screenshot of an exemplary web page depicting a website including a Customer page in Manage Projects for “Completed Projects” in accordance with an embodiment of the present invention.

FIG. 19 is a screenshot of an exemplary web page depicting a website including a Vendor page for “Manage Account” in accordance with an embodiment of the present invention.

FIG. 20 is a screenshot of an exemplary web page depicting a website including a Vendor page in Manage Account for “Edit Info” in accordance with an embodiment of the present invention.

FIG. 21 is a screenshot of an exemplary web page depicting a website including a Vendor page in Manage Account for “Transfer Funds” in accordance with an embodiment of the present invention.

FIG. 22 is a screenshot of an exemplary web page depicting a website including a Vendor page in Manage Account for “Withdraw Funds” Step 1 in accordance with an embodiment of the present invention.

FIG. 23 is a screenshot of an exemplary web page depicting a website including a Vendor page in Manage Account for “Withdraw Funds” Step 2 in accordance with an embodiment of the present invention.

FIG. 24 is a screenshot of an exemplary web page depicting a website including a Vendor page in Manage Account for “Transfer Funds” Step 3 in accordance with an embodiment of the present invention.

FIG. 25 is a screenshot of an exemplary web page depicting a website including a Vendor page in Manage Account for “Account Balance” in accordance with an embodiment of the present invention.

FIG. 26 is a screenshot of an exemplary web page depicting a website including a Vendor page in Manage Account for the “View All” button in Account Balance in accordance with an embodiment of the present invention.

FIG. 27 is a screenshot of an exemplary web page depicting a website including a Vendor page for “Manage Projects” in accordance with an embodiment of the present invention.

FIG. 28 is a screenshot of an exemplary web page depicting a website including a Vendor page in Manage Projects for “New Project Opportunities” in accordance with an embodiment of the present invention.

FIG. 29 is a screenshot of an exemplary web page depicting a website including a Vendor page in Manage Projects for a particular “Project Name” in the “New Project Opportunities” link or window in accordance with an embodiment of the present invention.

FIG. 30 is a screenshot of an exemplary web page depicting a website including a Vendor page in Manage Projects for a particular “Quote on Project: Project Name” link from the “Place a Bid” indicator, of FIG. 29, in accordance with an embodiment of the present invention

FIG. 31 is a screenshot of an exemplary web page depicting a website including a Vendor page in Manage Projects for “Open Quotes” in accordance with an embodiment of the present invention.

FIG. 32 is a screenshot of an exemplary web page depicting a website including a Vendor page in Manage Projects for “View Open Projects” in accordance with an embodiment of the present invention.

FIG. 33 is a screenshot of an exemplary web page depicting a website including a Vendor page in Manage Projects for “Projects Pending Approval” in accordance with an embodiment of the present invention.

FIG. 34 is a screenshot of an exemplary web page depicting a website including a Vendor page in Manage Projects for “Rate Customers” in accordance with an embodiment of the present invention.

FIG. 35 is a screenshot of an exemplary web page depicting a website including a Vendor page in Manage Projects for “View All Previous Project Opportunities” in accordance with an embodiment of the present invention.

FIG. 36 is a screenshot of an exemplary web page depicting a website including a “LocalManufacturing.com Message Boards” page in accordance with an embodiment of the present invention.

FIG. 37 is a screenshot of an exemplary web page depicting a website including a “Search Projects” page in accordance with an embodiment of the present invention.

FIG. 38 is a screenshot of an exemplary web page depicting a website including a Content Management System for “View Projects” in accordance with an embodiment of the present invention.

### BEST MODE FOR CARRYING OUT THE INVENTION

Reference will now be made to the exemplary embodiments illustrated in the drawings, and specific language will be used herein to describe the same. It will nevertheless be understood that no limitation of the scope of the invention is thereby intended. Alterations and further modifications of the embodiments illustrated herein, and additional applications of the principles of the embodiments as illustrated herein, which would occur to one skilled in the relevant art and having possession of this disclosure, are to be considered within the scope of the disclosed embodiments.

The terms “example” or “exemplary” are used herein to mean serving as an instance or illustration. Any aspect or embodiment described herein as an “example” or as “exemplary” is not necessarily to be construed as preferred or advantageous over other aspects or designs.

The term “anonymous” as used herein means that the customer can identify the bidding party or parties but the individual bidding party or parties cannot determine any information about other bidding parties.

The term “Customer” as used herein means the purchaser of goods and/or services from a vendor.

The term “Vendor” as used herein means the supplier of a good or part to the seller that is manufactured by the vendor.

The term “manufacture” or “manufactured” as used herein means the act or process of making something from raw materials by hand or by machinery. By way of example, a manufactured part or good may include a custom fabricated part or good.

Embodiments of the present invention are described herein in the context of a method, apparatus and system for connecting users via a network communication system or an electronic communication system, thereby enabling such users to seek or provide one or more anonymous bids for build-to-order or manufactured parts. It will be appreciated by those of ordinary skill in the art that the following detailed description is merely intended to be illustrative or exemplary and is not intended to be in any way limiting. For example, other embodiments of the present invention will readily suggest themselves to those skilled in that art having the benefit of this disclosure because such a development effort would be a routine undertaking of engineering for those of ordinary skill in the art having the benefit of this disclosure.

Generally, the following embodiments describe a method, apparatus and/or system for generating anonymous bids from Vendors to produce a manufactured good for a Customer. In at least one embodiment, the system, method and/or apparatus can be used for machining services for build-to-order or manufactured parts via a computer network communication system. In another embodiment, the system, method and/or apparatus can be used for build-to-order or manufactured computer harness parts (e.g., a flexile electrical interconnection) via a computer network communication system. In other embodiments, the system, method and/or apparatus may also apply to various manufactured goods or services, such as weldments, finishing work, assembly, plating, coating, inspection, hardware assembly, contract manufacturing, and/or circuit boards.

In at least one embodiment, the present invention provides a method for generating a request for quote for a build-to-order part(s) via a computer network system; receiving one or more bids for the request for quote via a computer network system; accepting a bid via a computer network system; generating a purchase agreement via a computer network system; generating an invoice for a completed project via a computer network system; accepting the completed project via a computer network system; and making payment for the completed project via a computer network system.

The present embodiments also include pertinent databases that manage the efficient transfer of information between Vendors and Customers and provide status indicators to show the progress of the purchase/manufacture process. By way of example, the databases may include operational databases that store Customer and Vendor information, credit and demographic information and financial information; analytical databases that allow for the retrieval of records; etc.

Generally, a network communication system (e.g., Internet, LAN, WAN, etc.) enabling the system, method and/or apparatus of the present embodiments may include one or more customer computers, one or more Vendor computers, and one or more server computers configured to communicate with one another. The server may include one or more databases for storing and retrieving data, such as files, programs, and/or web pages that can be controllably accessed by Customers and Vendors via the network communication system. The network communication system utilizes a software product or platform (e.g., a web based application) including instructions that perform steps for automating the bidding process when data is entered into required fields or indicators of the software program or web based application and executed by a computer.

It is to be understood that a computer within this network communication system may include any electronic device that can store, retrieve and/or process data, such as an Internet device, a cellular phone, a desktop computer, a portable computer, a personal digital assistant, etc. Accordingly, the computer may contain a main unit with various circuits, memories, processors, and interface circuits interconnected through an address/data bus. This main unit can be cooperatively and/or communicatively coupled to various input devices (mouse, keyboard, etc.) and one or more peripheral devices, such as a printer, a display, etc. The main unit may also be cooperatively and/or communicatively coupled to one or more storage devices, such as a hard drive, CD/DVD drive, flash drive, etc. The computer may also be connected (e.g., by Ethernet, telephone, coaxial, etc.) with other network devices (e.g., computers) through the connection to a network communication system.

By way of example, the system, method and/or apparatus of the current embodiments may provide a secure (e.g., encrypted), web-based portal that provides access to all participating machining service providers (e.g., a Vendor) within a predetermined geographical local area and beyond. By preferentially utilizing a multitude of geographically local machining or other manufacturing service providers, the web-based portal can enable the elimination of “back-ups” that often occur from the use of a single machining or manufacturing facility. The web-based portal provides an electronic environment where multiple competitive bids can be received for each service request submitted.

In at least one embodiment, a web-based application can be accessed directly from a user's desk top computer, such as a Customer's computer. Files, such as design files, can be uploaded via the network communication system to a server from the Customer's computer, where the files can be distributed to the approved service providers (e.g., Vendor) for quotation of services required to supply manufactured goods to the end Customers. Approved Vendors can be provided with passwords to access the software program or web-based application where they can access the design files to provide quotes to the Customer. All of these actions can be automated through the web-based application to insure that overhead costs are minimized and the best value is provided to a Customer(s).

Generally, the Customer can be provided with a password to satisfy security protocol. If additional security requirements are needed for a specific account, the web-based application can be modified to institute those features. When a user (e.g., a Customer) logs onto the web-based application, they can directly upload files or utilize a build-to-order software interface to request quotations from approved local service providers (e.g., a Vendor). The user can select from a list of known service providers, select a single service provider or allow all service providers to quote on their project. Additionally, the web-based application will also permit the user to select any additional services that they need such as finishing of parts, inspection, pick up or delivery, etc.

Once all options are selected, a notification can be automatically sent to all of the selected service providers so that they can quote the parts to be manufactured or produced. In at least one embodiment, the customer has the option to select a single source for their work, although the vendor(s) will have no knowledge of this option, thus keeping the bid process competitive.

In order to insure that quotes are provided to the Customer in a timely fashion, the web-based application can include an integrated escalation process where quote submissions are tracked and a Company (e.g., a Broker or manager of the web based application) can be notified if the quoting deadline is approaching without submissions so that service providers can be contacted to prompt them on submissions. If no quotes are received, the Company can contact the Customer to inform them that this is the case and an appropriate course of action can be developed and executed to extend the search for a service provider. Generally, the Company oversees the management and operation of the service provided by the web-based application.

In at least one embodiment, Vendor bids can be submitted electronically using the web-based application to enable an efficient electronic delivery (e.g., via email, text or voice) to the Customer for review and selection of the desired service provider. The bids delivered to the Customer can include all fees required to complete the desired work. Bids can be valid for a predetermined set amount of time (e.g., 3 days, 10 days, 30 days, etc.) and can be subject to changes upon revisions to the original quoting data. The Customer can select the desired service provider based on their internal criteria and place an order with the Company or the website to get the work completed.

Once the service provider is selected, the Customer can select the appropriate method to generate a Purchase Order with the Company or website. For orders that are below a certain maximum value, the Customer can place an order directly using their corporate credit card (if allowed) using the web-based application. For larger value orders, the Company or website can work with the Customer's purchasing department to get a contract in place to cover the cost of requested work. In at least one embodiment, the Company or website can provide a means to the Customer's purchasing organization to place orders electronically using the web-based application (e.g., via a PayPal® account).

After selecting the service provider, the Company or website can set up a secure hyperlink site where the Customer and service provider communicate additional details about the request. This hyperlink site can then be used to generate an updated work order by the Company or website.

Once an order is placed with the Company or website, the selected service provider can be notified electronically that they have won the proposal and a purchase order with a unique identifier (e.g., a number or other alpha-numeric string) can be sent to the service provider to confirm the order. The service provider may be required to accept the order and a response that the order has been received and accepted by the selected service provider can be generated electronically and copies can be sent to the Customer, their Purchasing Organization and the Company.

In at least one embodiment, any interaction between the service provider and the Customer required to successfully complete the work can be facilitated by the service provider. The Customer may also contact the service provider at any time during the project without involving the Company. Any interactions between the Customer and service provider that require a change in the original agreement must go through the Company or website to insure the best quality service is provided to the Customer. To insure that changes that involve significant modification to the original scope of work are captured and accounted for, a change request may need to be generated within the web-based application or system. A change request may require additional approval of the involved parties and may require an additional or amended purchase order to be generated.

The Company or website can track the progress of the work and provide expediting services as required. As progress updates are available from the service providers they can be sent to the Customer electronically to facilitate good communication with the Customer. In at least one embodiment, the Customer can receive an electronic communication (e.g., email, text, or voice) regarding the status of their order one week prior to the agreed upon completion date for planning purposes.

The completion date information can be used to develop a transportation schedule for part pick-up and delivery for the following week. In at least one embodiment, the Customer can have the option of shipping complete or designating acceptance of “OK to part ship.” The transportation service may request status within a day of the scheduled pick-up from the service provider to make sure that parts are on schedule and may provide an electronic update to the Customer when that information is available. When the transportation service receives the manufactured good from the service provider, the transportation service personnel can verify that part counts are correct and receive the traveler from the service provider.

The transportation service can scan all travelers into their computer system to generate an electronic record that the Customer parts are received from the service provider and in the hands of the transportation service. The parts can be delivered to the Customer's receiving department on the same day as they are picked up from the service provider within geographical limits. Upon delivery of the parts to the Customer's receiving department, the transportation service can again log that data into the computer to generate an electronic file showing receipt of parts at the Customer's site. A copy of this receiver can be sent to the Customer, the Customer's Purchasing Department and the Company or website. The receipt of the receiver by the Company or website can trigger the generation of an electronic invoice, which can be submitted electronically to the Customer for payment due for the service rendered.

As a final step in the process, the Customer and/or service provider can be provided with the ability to rate the service that they received using the Web-based application or system from the other party. For example, the rating information may include a number or star designation along with a review section that may include comments. This rating information can be made available to all users of the system including Customers and service providers. By way of example, this metric can allow future Customers to base their purchases with confidence that the selected service provider will provide quality service. This metric can also provide the service providers with a tool that they can use to improve their services. And finally, this information can be used by the Company or website to work with service providers to insure that the best possible service is available to the Customer.

Generally, the following description of how a request for quote or a project flows through the web-based application via the network communication system is meant to be exemplary and non-limiting. Initially, a Customer can login to the web-based application and/or to the Company Website: http://www.Localmanufacturing.com via a computer or other electronic interface device. At the Customer home page of the web-based application, the Customer may then click on a button called “Create Project,” for example. Upon clicking on the “Create Project” button, a new screen can appear presenting a fill-in form requesting information about the Customer and its prospective project. Upon filling in at least the required fields, the Customer may submit the project with the appropriate design files by clicking on a button designated “Submit,” for example.

After the Customer's project is submitted, the web-based application via its software platform can automatically assign a unique identifier, such as a project identifier alphanumeric character string, to the Customer's project and automatically send notification of this to the Customer. The Customer can use this unique project identifier for keeping track of this particular project. Additionally, after the Customer's project is submitted, the web-based application may also automatically generate and send notification to all selected Vendors that a “New Project” meeting their relevant experience or qualifications is currently available for bidding.

In at least one embodiment, upon receipt of the notification of a “New Project,” the Vendor may click on a link (e.g., a hyperlink or a hypertext function) within an email notification that takes the Vendor to a web page where the Customer project can be bid on. In such cases, the web page may include information and links about the Customer project and/or fill-in fields or indicators for the Vendor to enter their bid information. After filling in at least the required indicators or fill-in fields, the Vendor may submit their bid by clicking on a button designated “Place Bid,” for example. Additionally, it is to be understood that the Vendor may also bid on the project by logging-in to the website via the Vendor sign-in function.

Upon placing their bid, the Customer project stays on the “New Project Opportunities” list of the Vendor's web pages and a copy of the Customer project with the corresponding bid can be added to the “Open Quotes” list of the Vendor's web pages as well. Additionally, the “Bid Column” on the Customer's “Open Projects” web page is updated to reflect the newly submitted bid of the Vendor.

In at least one embodiment, after the preset bidding period has expired, the Customer can view all of the bids by accessing the “Open Projects” web page. The Customer may then choose the preferred Vendor by utilizing their internal selection criteria and/or metrics. Upon selecting the preferred Vendor, the Customer receives an automatically generated electronic notification of the selected Vendor and the selected Vendor receives an automatically generated electronic notification of the won bid. In such cases, the Vendor may accept the won bid via the automatically generated notification or they can log into the Company Website http://www.localmanufacturing.com and accept the won bid via the website using, for example, the “Open Quote” web-page and its “Others” message link, which instructs the Vendor to accept or deny the offer by clicking on a “Accept/Deny Offer” button.

After selecting the “Accept/Deny Offer” button, a new widow may appear where the Vendor may select a field that says “Yes. I accept.” or a field that says “No. I do not accept.”. If the Vendor selects “Yes. I accept.” and clicks on a “Submit” button, a message can be displayed authorizing the Vendor to begin work on the quoted project. The Vendor may also be given the Customer's contact information and/or email address for future direct contact. If the Vendor selects “No. I do not accept.” and clicks on the “Submit” button, notification can be automatically generated to alert the Customer and the Company or the website so that they may work together to resolve the issue.

Upon acceptance of the project by the Vendor, the project can be transferred to the Vendor “View Open Projects” web page or window and a “Notify” tab or button can be automatically made active or hot in the Vendor's “Project Completed” column. Additionally, the project status can change from “Frozen” to “Working” in the Customer's “Manage Projects/Open Projects” link, window, or web page.

After completion of the project, the Vendor can log-on to the web application or the website and access the Vendor “Manage Projects/View Open Projects” link, window, or web-page and click on the “Notify” button associated with the completed project under the “Project Completed” column, for example. Upon notifying the Customer that the project is completed, the “Notify” button can change to a “Customer notified” message and copy of the project can be moved to the Customer and/or Vendor “Pending Approval” link, window, or web page. Additionally, a message may appear in the Customer's “Manage Projects/Open Projects” status column indicating that the project has moved to the “Pending Approval” stage.

Next, the Customer receives the manufactured good from the Vendor via a delivery service, for example. Upon delivery, the Customer may inspect the part or product or manufactured good and determine if the Customer will accept or reject.

If the product or manufactured good is acceptable, the Customer may log-on to the web application and/or website and can select a “Yes” button under the “Projects Accepted” column in the Customer's “Manage Project/Pending Approval” link, window, or web-page. After accepting the product or manufactured good, the project can be moved to the Customer “Manage Account” link, window or web page for the Vendor to be paid. Also, the status in the Vendor “Manage Project/Pending Approval” link, window, or web page can change to “Project Accepted” to notify the Vendor of its current status.

If the product or manufactured good is not accepted or is rejected, the Customer may log-on to the web application and/or website and can select a “No” button under the “Projects Accepted” column in the Customer's “Manage Project/Pending Approval” link, window, or web-page. Upon selecting “No,” an automatically generated electronic notice is sent to the Vendor and/or the Company to notify them that work is incomplete and that they should contact the Customer.

Per above, if the product or manufactured good is acceptable, the Customer may initiate payment by selecting the Customer “Manage Account” tab or button and then selecting the “Pay” option to pay the Vendor for the completed and accepted work.

After selecting the “Pay” button, a window or link may appear with a fill-in form requesting information about the Vendor. Some fields within the fill-in form may include Vendor name (or verification of Vendor name), the project's unique identifier, and/or the amount to be paid to the Vendor. After filing in at least the required fields, the Customer may submit the payment by selecting or clicking on the “Send Payment” button, for example. The Vendor can receive an automatically generated electronic notification letting them know that payment has been made. In such cases, the notification may state what project the payment is being made for by utilizing the project's unique identifier, for example.

The FIGS., which follow, depict by way of example and not by limitation, an exemplary system, method and apparatus and they are not to be construed as limiting. It is to be understood that a plurality of conventional processes that are well known within the art and not repeated herein, may precede or follow the steps within a FIG. Moreover, it is to be understood that many modifications, additions, and/or omissions may be made to the below described system, method and/or apparatus without departing from the scope of the claimed subject matter. For example, as one of ordinary skill in the art would recognize, the below described processes may include more, fewer, or other steps. Additionally, steps may be performed in any suitable order without departing from the scope of the present invention.

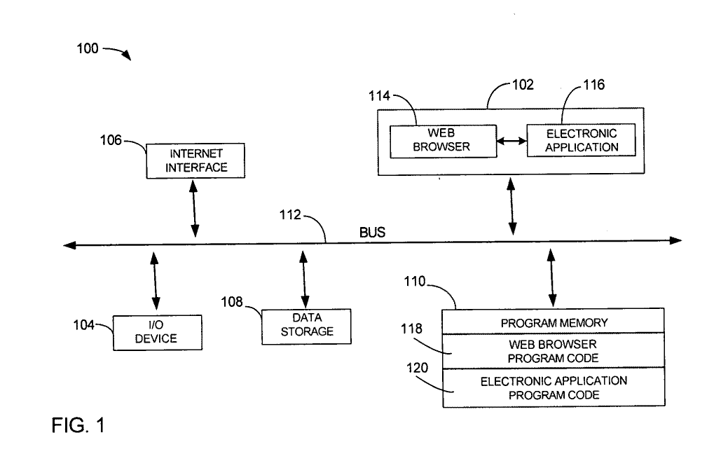

Referring now to FIG. 1, therein is shown an exemplary diagram depicting the physical structure of a computer system 100 in accordance with an embodiment of the present invention. The computer system 100 may include one or more of a processor 102, an input/output device 104, an Internet interface 106, a data storage unit 108, a memory device 110 and a bus 112.

Generally, the computer system 100 may include a personal computer, a laptop, a cellular telephone, a personal digital assistant, a wireless Internet device, a television set, or any other electronic interface device capable of presenting data that is well known within the art. In at least one embodiment, the processor 102 can be physically and/or electrically coupled to the Internet interface 106, the input/output device 104, the data storage unit 108, and the memory device 110 via the bus 112. Stated another way, each of the processor 102, the Internet interface 106, the input/output device 104, the data storage unit 108, and the memory device 110 can be physically and/or electrically coupled to the bus 112.

By way of example, the processor 102 may include a microprocessor and the bus 112, although illustrated as a single bus, may include more than one or a series of buses and bridges. In at least one embodiment, the processor 102 may act upon instructions and/or code of a web browser application 114 and/or an electronic application 116, such as electronic mail (email). In such cases, the processor 102 carries out the instructions of a computer program, e.g., a software program, to perform the basic arithmetical, logical, and input/output operations of the computer system 100.

The processor 102 can receive information from a user of the computer system 100 via the input/output device 104. Generally, the input/output device 104 permits the transference of commands and/or data to and from the computer system 100 and other peripheral electronic interfaces. By way of example, the input/output device 104 may include a mouse, a keyboard, a touchscreen, a display unit for generating visual images, a printer, an Ethernet interface, and/or a Universal Serial Bus interface.

The Internet interface 106 coupled to the bus 112 permits an exchange of data between the computer system 100 and other network devices, such as other personal computers and/or servers. The Internet interface 106 connection may include one or more of a telephone line, a Digital Subscriber Line, Ethernet, wireless, and/or coaxial cable connections, for example.

The data storage unit 108 coupled to the bus 112 may include a hard disk drive, a CD drive, a DVD drive, or other suitable solid state storage devices.

The memory device 110 coupled to the bus 112 may include volatile memory and/or non-volatile memory. Generally, the memory device 110 can store software programs and/or electronic data indicative of documents, files, programs, or web pages that are executable on the processor 102. In at least one embodiment, the memory device 110 may include a web browser program code 118 and/or an electronic application code 120, such as an electronic mail (email) code.

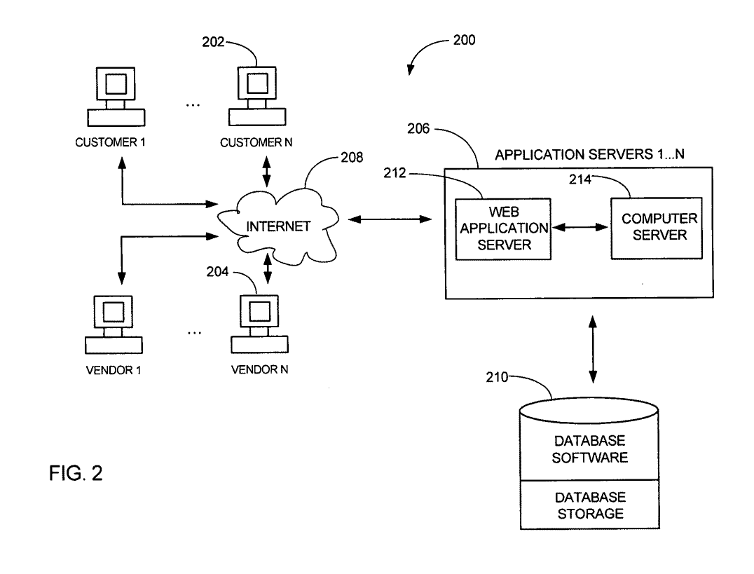

Referring now to FIG. 2, therein is shown a general architecture of an exemplary network communication system 200 in accordance with an embodiment of the present invention. Generally, one or more user interface device(s) (e.g., cellular telephone or personal computer) are communicatively coupled to one or more application servers including a database via a public or private internet/LAN/WAN or similar connection.

In at least one embodiment, a graphical user interface (GUI) can be displayed on one or more of a first device 202 and/or a second device 204 connected to one or more of a server 206 via the Internet 208. Generally, the first device 202 and the second device 204 can be referred to as clients. In such cases, the first device 202 can be a Customer electronic interface device and the second device 204 can be a Vender electronic interface device substantially similar or the same as the computer system 100, of FIG. 1. However, it is to be understood that the first device 202 may also be the Vendor electronic interface device when the second device 204 is the Customer electronic interface device.

Generally, the server 206 may include a web application server 212 and a computer server 214 that may serve as the application layer of the current embodiment. However, it will be appreciated by those skilled in the art that the server 206 may also include other servers such as a file server, a database server and/or an electronic mail server. By way of example, the electronic mail server (not shown) may send and receive electronic messages to and from the first device 202 and/or the second device 204. The electronic mail server can be a storage area for e-mail messages received from the Internet 208. In such cases, the electronic mail server may consist of a storage area, a set of user definable rules, a list of users and a series of communication modules.

In at least one embodiment, the web application server 212 can provide a system for sending out web pages in response to Hypertext Transfer Protocol (HTTP) requests from remote browsers, such as the first device 202, the second device 204, and/or other users. Stated another way, the web application server 212 can provide web pages to users of the system that can be displayed via the GUI present on the first device 202 and/or the second device 204. In at least one embodiment, the server 206 and/or the web application server 212 may contain and execute the program, software, and/or web application code for the website http://www.localmanufacturing.com described herein.

The computer server 214 may include a processor (e.g., a central processing unit), a random access memory (RAM) for temporary storage of data, and/or a read only memory (ROM) for permanent storage of data. As is known in the art, the computer server 214 may be generally controlled and coordinated by operating system software, wherein the operating system controls allocation of system resources and performs tasks such as processing, scheduling, memory management, networking, and I/O services, among other things. In such cases, the operating system operating in the system memory and executed by the CPU can control and/or coordinate with the operation of the other elements of the network communication system 200.

As used herein, the term “Internet” generally refers to one or more distinct networks that can function jointly and appear as a single network to a user. The term commonly refers to the so-called world-wide web or the world wide “network of networks” that are connected to each other using the Internet protocol (IP) and other similar protocols responsible for routing packets of information across network boundaries. Although the term “Internet” is commonly associated with a public network, the term “Internet” as used herein includes both public and private networks including systems having architectures dissimilar to that shown in the current embodiment.

Generally, the database 210 may include one or more storage medium that can store software, data and information, digital images, system data and/or any other data or information required by the other components of the network communication system 200. In at least one embodiment, the database 210 may include a set of computer programs that controls the creation, maintenance, and/or the use of the database 210. By way of example and not by way of limitation, the database 210 may include a database management system, an object-oriented database management system, a network database management system, a relational database management system, a file system or other conventional database systems known in the art. Additionally, it will be appreciated by those skilled in the art that the database 210 can be accessed via a query language, e.g., a Structured Query Language (SQL), or other conventional computer languages used to make queries into databases known to one of ordinary skill in the art.

As is evident to one of ordinary skill in the art, the server 206 and the database 210 can be connected to the Internet 208 through one or more of a router (not shown), a switch (not shown), a firewall (not shown), and/or a load balancer (not shown), which is commonly employed for balancing traffic across multiple servers.

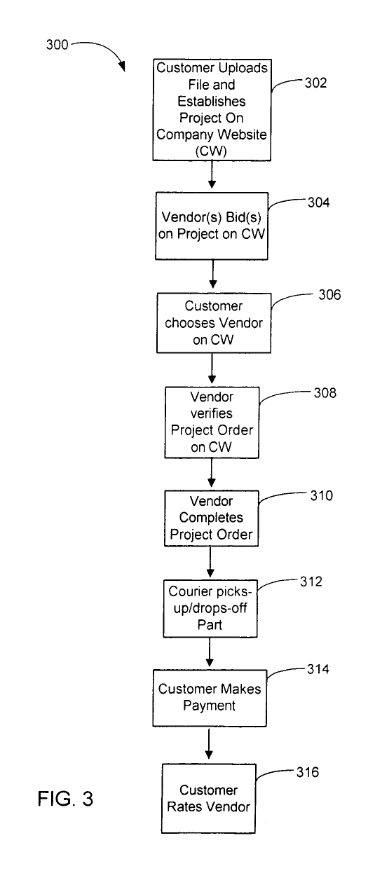

Referring now to FIG. 3, therein is shown a flow chart depicting an exemplary process or method 300 for a request for bid for a build-to-order part and/or manufactured good in accordance with an embodiment of the present invention. Generally, the method 300 can be implemented by one or more software programs, which can be stored in one or more servers, databases and/or memories and executed on one or more processors within a computer, computer system, and/or network communication system.

Generally, the method 300 can be begin with a Customer uploading data and/or a file to the Company Website (e.g., http://www.localmanufacturing.com) via a file transfer protocol, for example, to establish a project for bidding in a block 302. In at least one embodiment, the data and/or files may include digital product development information that conveys data, such as materials, processes, dimensions, and/or tolerances, according to application-specific conventions for computer aided design software packages in either two-dimensions or three-dimensions for the desired final product. In such cases, the data and/or files may include tools such as, computer aided engineering modules, finite element analysis modules, computer aided manufacturing modules, and/or computer numerical control instructions. By way of example and not by way of limitation, the tools may more specifically include AUTOCAD® or SOLIDWORKS® data or files.

After the Customer data and/or files are uploaded to the Company Website, an allowed Vendor may access the files via their electronic communication device after receiving notification of the request for work (RFW). In at least one embodiment, the Vendor may access the files by downloading or viewing the files via the Company Website. If, after reviewing the RFW, the Vendor is able to perform the requested service in the specified time and manner, the Vendor can bid on the project via the Company Website in a block 304.

After the close of the bidding period, the Customer may then choose a Vendor via the Company Website in a block 306. In choosing a Vendor, the Customer may employ any deterministic metric. However, it will be appreciated by those skilled in the art that such metric may include information available via the Company Website, such as price, time, quality, abilities, qualifications, Company Website Vendor rating and/or Company Website Vendor comments.

Subsequent to the Customer choosing a Vendor via the Company Website, the Vendor receives notification of its selection. At such time and upon further review, the Vendor may then accept, reject, and/or partially accept the project order via the Company Website in a block 308. If the Vendor accepts or verifies the project order via the Company Website, the Customer and Vendor may then exchange contact information for purposes of communication.

Upon completion of the accepted project by the Vendor, the Vendor indicates such completion of the project via the Company Website and the Customer receives notification of its completion in a block 310. At such time, the product produced from the RFW can be delivered to the Customer in a block 312.

After delivery and acceptance of the product manufactured by the Vendor, the Customer can make payment for the services rendered via the Company Website in a block 314. However, it is to be understood that if the product produced by the Vendor is unacceptable to the Customer, the Customer and Vendor may negotiate the acceptability of the product. In such cases, a significant modification to the original scope of work may require a change request to be generated within the Company Website.

Upon completion of the project, the Customer and/or the Vendor may rate the others performance to provide a metric for future Customers and/or Vendors to base their decisions upon in a block 316.

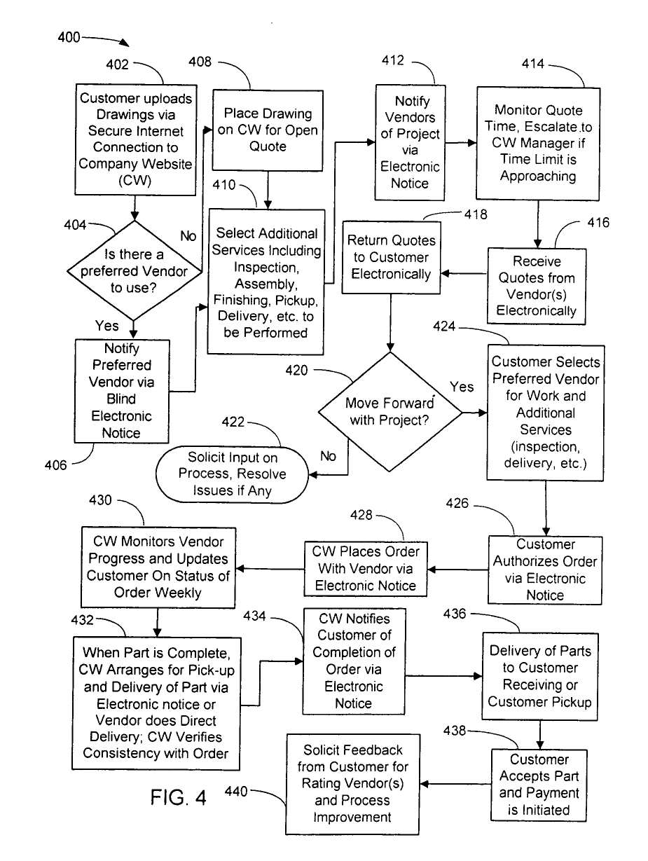

Referring now to FIG. 4, therein is shown a flow chart depicting an exemplary process or method 400 for a bid request for a build-to-order part and/or manufactured good in accordance with an embodiment of the present invention. Generally, the process described can be implemented by one or more software programs, which can be stored in one or more servers, databases and/or memories and executed on one or more processors within a computer, computer system, and/or network communication system. In at least one embodiment, the method 400 can be implemented by the web based application described herein.

Generally, the method 400 can be begin with a Customer uploading a project request, which may include data and/or a files, to the Company Website (CW) via a secure internet connection to establish a project for bidding in a block 402. In at least one embodiment, the data and/or files of the project may include digital product development information that conveys data, such as materials, processes, dimensions, and tolerances, according to application-specific conventions for computer aided design software packages in either two-dimensions or three-dimensions for the desired final product. In such cases, the data and or files may include tools such as, computer aided engineering modules, finite element analysis modules, computer aided manufacturing modules, and/or computer numerical control instructions. By way of example and not by way of limitation, the tools may more specifically include AUTOCAD® or SOLIDWORKS® data or files.

After uploading the project, the Customer may then decide if there is a preferred Vendor for the project in a block 404. If there is a preferred Vendor, the process flow goes to a block 406 and if there is not a preferred Vendor the process flow goes to a block 408.

Accordingly, if there is a preferred Vendor, the software, the web application, and/or the Company Website can be set-up to only automatically notify the preferred Vendor via a blind electronic notice in a block 406. This blind electronic notice would let the Vendor know that there is a job to bid on, but would not let the Vendor know that they are the only Vendor selected for the bidding process. If a preferred Vendor is notified in the block 406, the process then advances to a block 410.

If there is no preferred Vendor, the project and/or the data and files can be placed on the Company Website for an open quote request from one or more Vendors in a block 408. Additional services, such as but not limited to, inspection, assembly, finishing, pick-up, and/or delivery can be selected by the Customer for the Vendor or others to perform in a block 410. After all services are selected by the Customer, the Company Website can generate an automatic notice (e.g., an electronic notice such as email) and send it to all applicable Vendors in a block 412.

After submission of a Customer request for quote for a project, the Company and/or the website can monitor the quote time and escalate to the Company's management if the time limit for the quote request is approaching and a sufficient amount of quotes (e.g., two or more) has not been received in a block 414. Such active monitoring will ensure that service providers can be contacted to prompt them on submissions. If no quotes are received, the Company can contact the Customer to inform them that this is the case and an appropriate course of action can be developed and executed to extend the search for a service provider. Generally, the Company oversees the management and operation of the service provided by the web-based application and/or the Company Website.

After the Vendors have been notified of the project, the web application and/or the Company Website can receive bids or quotes from the Vendors in a block 416. In at least one embodiment, the Vendor bids or quotes can be returned electronically; however, it is to be understood that other methods are acceptable, such as phone or fax. After receiving the Vendor bids or quotes, the web application and/or the Company Website can automatically generate a notice that is sent to the Customer notifying them of the one or more bids in a block 418. In at least one embodiment, the Vendor bids or quotes sent to the Customer can be sent electronically; however, it is to be understood that other methods are acceptable, such as phone or fax.

After receiving the Vendor bids or quotes, the Customer may then decide if the project will move forward in a block 420. If no, the process flow goes to a block 422 and, if yes, the process flow goes to a block 424.

As such, if the Customer decides not to go forward with the project, the Company may contact the Customer to solicit input on the project or process and/or resolve any issues, if any, in the block 422. If the Customer does decide to go forward with the project, the Customer selects the preferred Vendor and any additional services for the project in the block 424. In at least one embodiment, the Customer can authorize the order for work to begin on the project via the Company Website in a block 426.

Then, once the Company and/or the Company Website has received authorization for work to begin on the project, a notice (e.g., an electronic notice) can be automatically generated by the Company Website and sent to the Vendor in a block 428. After notifying the Vendor of their winning bid and the acceptance of the project by the Vendor, the Company can then monitor the Vendor's progress and periodically update the Customer on the status of their order weekly in a block 430. However, it is to be understood that the frequency of the update cycle is not essential and may include hourly, daily, weekly, or monthly time frames.

Subsequent to completion of the part, product or manufactured good, pick-up and delivery can be arranged in a block 432. The pick-up and delivery can be arranged by the Customer, the Vendor and/or via the Company Website. In at least one embodiment, after the Vendor has notified the Company Website that the part is complete and ready for delivery, the Company Website can automatically generate a notice that is sent to a local courier or delivery service for pick-up and delivery of the part. In another embodiment, the Company can receive the product and perform additional services on the product, such as inspection and/or metrology, for example.

After the Vendor has notified the Company Website that the part is complete, but before delivery of the part, the Company Website can automatically generate a notice that is sent to the Customer notifying them of the completion of the project or part in a block 434.

After pick-up and delivery has been arranged, the part, product or manufactured good can be picked-up by the Customer or delivered to the Customer and/or the Customer's receiving department in a block 436.

Subsequent to the Customer receiving the part, product or manufactured good, the Customer may accept and initiate payment for the services rendered via the Company Website in a block 438. In such cases, the payment may be made directly to the Vendor, to the Company Website, or to a third party (e.g., PayPal®). However, it is to be understood that the current embodiment may also include instances wherein the acceptance of the part and payment for the part are not accomplished via the Company Website.

After the Customer project has been completed and paid for, the Company Website may then solicit feedback from the Customer about the Vendor's performance (and vice-versa) and/or about ways to improve the overall process of the website application in a block 440. Such feedback, which may include a star rating system of the others' performance and/or a comments section, can provide a metric for future Customers and/or Vendors to base their decisions upon. By way of example, the Vendor star rating system may rate a Vendor's quality, accuracy, timeliness, and/or overall professional ability; whereas the Customer star rating system may rate a Customer's accuracy of initial order, number of changes, payment history and/or overall professional ability. However, it is to be understood that the preceding examples are not essential, what is important is that the star rating system can employ any metric deemed deterministic for measuring the quality of service provided.

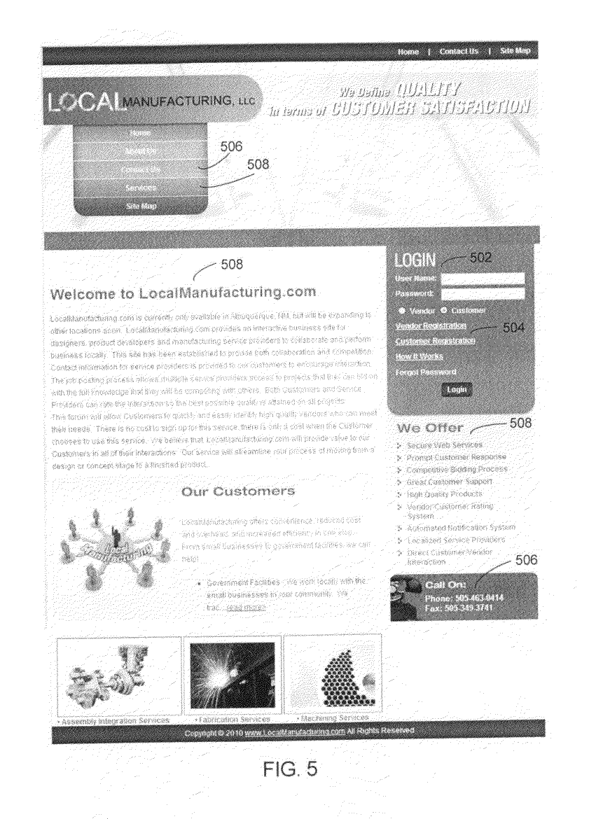

Referring now to FIG. 5, therein is shown a screenshot of an exemplary web page depicting a Home Page of the Company Website in accordance with an embodiment of the present invention. On this page can be seen a login field 502, a Customer/Vendor registration link 504 for new users, a contact information link or field 506, and general information fields 508 about the services provided.

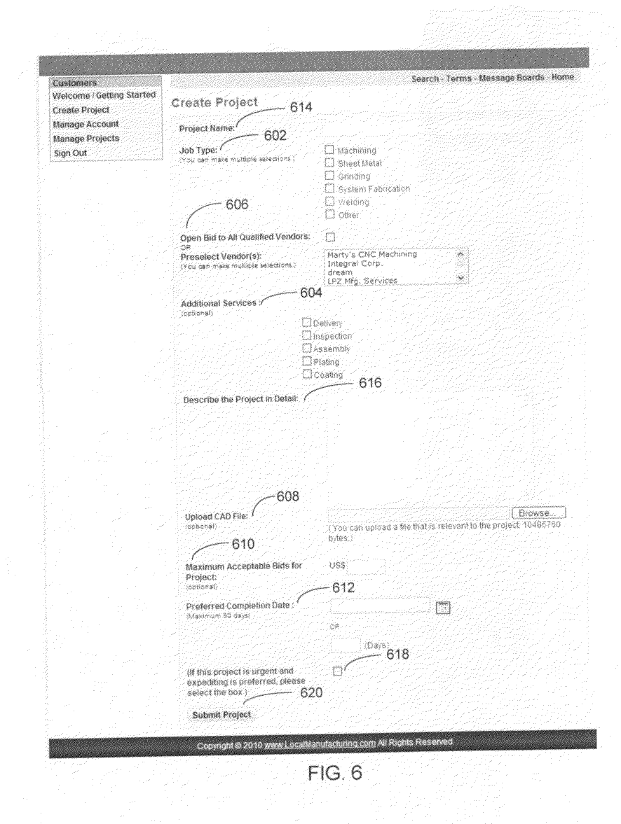

FIGS. 6-18 which follow, depict screenshots of exemplary web pages illustrating the Company Website from the Customer side of the website, i.e., web pages as seen by the Customer after logging-in to the website. It is to be understood that FIGS. 6-18 depict by way of example and not by limitation, exemplary Customer web pages and they are not to be construed as limiting.

Referring now to FIG. 6, therein is shown a screenshot of an exemplary web page depicting a website including a Customer page for “Create Project” in accordance with an embodiment of the present invention. Generally, this web page may include a job type field 602, an additional services field 604, a bid type field 606, an upload file field 608, a budget range field 610 and a preferred completion date field 612.

In at least one embodiment, the Customer can fill in the “Project Name” field 614 and select one or more “Job Type”, such as machining, sheet metal, grinding, system fabrication, welding, or other from the “Job Type” field 602. The Customer can also select the bid type, e.g., all qualified Vendors or just pre-selected Vendors, from the bid type field 606. As previously stated, if the Customer chooses the pre-selected Vendors option, the pre-selected Vendors will not be aware that they are the only bidder on the project to ensure competitive pricing. The additional services field 604 can allow the Customer to select from optional services as part of the posted project, including but not limited to, delivery, inspection, assembly, plating, coating, and/or metrology inspection.

The upload file field 608 can allow the Customer to optionally upload electronic files for Vendors to use in developing quotes and/or bids on the posted project. In at least one embodiment, the uploaded file can be a requirements file or document. Additionally, a “Describe the project in detail” field 616 can be provided for the Customer to provide a detailed description of the project requirements. This information area can be intended to provide the potential Vendors with adequate information so that they can provide a more accurate quote and/or bid on the project.

The preferred completion date field 612 can also be provided for the Customer to enter a requested completion date for the posted project. In at least one embodiment, if the Customer project is deemed to be urgent, the Customer may also select an urgent box/field 618, and the new project posting can be expedited through the process to ensure timely completion. Subsequent to filling in the required fields, the Customer may then submit their request via a “Submit Project” button, tab or indicator 620, for example.

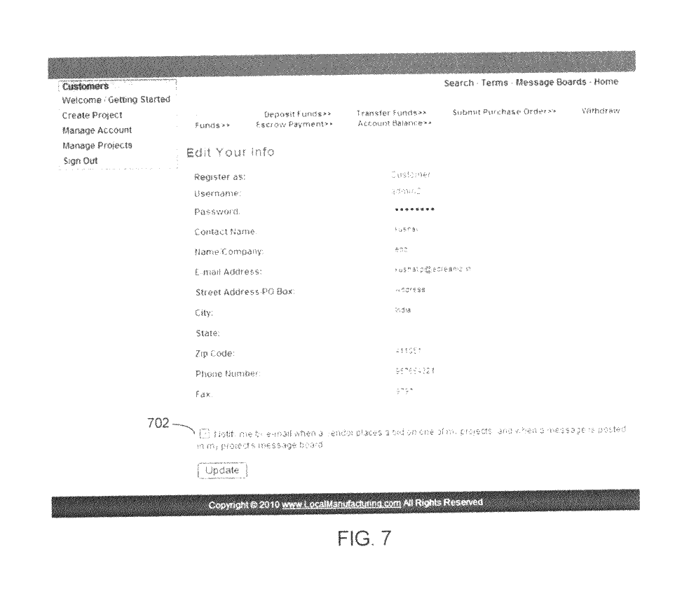

Referring now to FIG. 7, therein is shown a screenshot of an exemplary web page depicting a website including a Customer page in Manage Account for “Edit Info” in accordance with an embodiment of the present invention. The web page(s) associated with the “Manage Account” link or window provide an area for managing financial transactions associated with the website. From the “Manage Account” web page, a Customer may, but is not limited to, editing their information, deposit funds, transfer funds, submit purchase order, withdrawal funds, escrow payment, and/or determine their account balance.

Under the “Edit Info” tab or link, the Customer can change their information (e.g., username, password, contact name, name of company, email address, company address, phone, and/or fax number) so that their account can be current. In at least one embodiment, the “Edit Info” web page may include a check box 702 that enables electronic notification when a bid is submitted to the Customer. This feature allows the Customer to be aware of the current bidding process without the need to continuously check their Customer account. In other embodiments, this check box 702 that enables electronic notification can also be located on other web-pages, such as the Customer “Create Project” web page, for example.

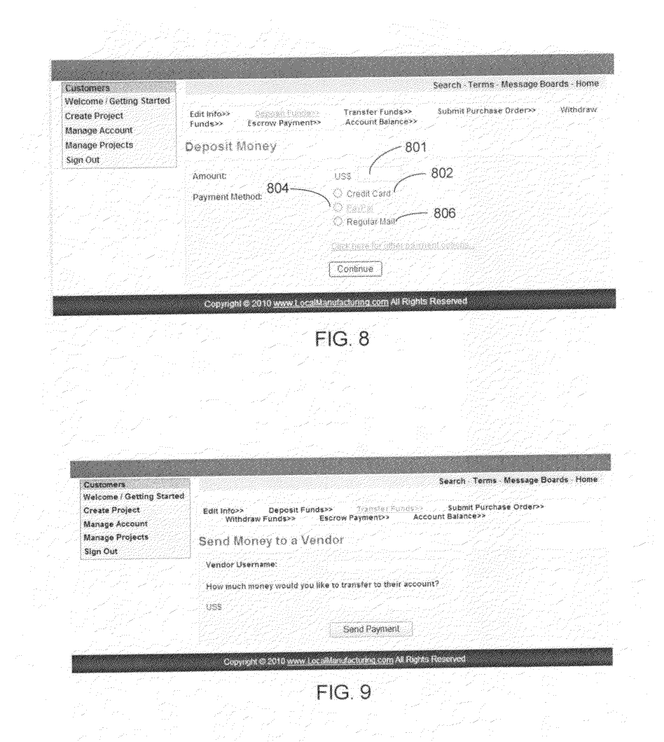

Referring now to FIG. 8, therein is a screenshot of an exemplary web page depicting a website including a Customer page in Manage Account for “Deposit Funds” in accordance with an embodiment of the present invention. Under the “Deposit Funds” tab or link, the Customer can deposit funds (e.g., a specified amount in field 801) into their account so that work can be performed. Generally, there can be a variety of secure funding mechanisms available to the Customer to submit payments to their account including, but not limited to, credit card 802, Paypal® 804, 2Checkout®, Stormpay® and/or direct mail submission 806. Preferably, this function or option is only to be used for special cases, because in most instances, the payment will be made when the Vendor is chosen.

Referring now to FIG. 9, therein is screenshot of an exemplary web page depicting a website including a Customer page in Manage Account for “Transfer Funds” in accordance with an embodiment of the present invention. Under the “Transfer Funds” tab or link, the Customer can submit payment to the Vendor once the work has been completed and accepted.

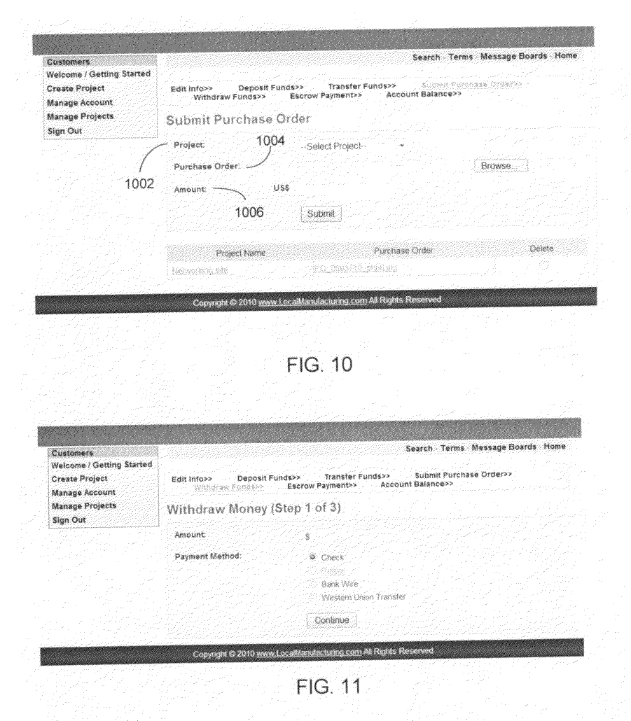

Referring now to FIG. 10, therein is a screenshot of an exemplary web page depicting a website including a Customer page in Manage Account for “Submit Purchase Order” in accordance with an embodiment of the present invention. Under the “Submit Purchase Order” tab or link, the Customer can electronically submit a purchase order for funding a project. In such cases, the Customer's credit must be established with the website prior to using this function. Generally, the term “credit” means the right granted by the Company and/or the website to a debtor (e.g., the Customer) to defer payment or debt or to incur debt and defer its payment.

Under a project field 1002, the Customer may select the project for which they desire to submit a purchase order. After selecting the project, the Customer can upload their file by utilizing a browse button or tab adjacent a purchase order field 1004. In an amount field 1006 the Customer can demarcate the requested monies for the purchase order.

Referring now to FIG. 11, therein is a screenshot of an exemplary web page depicting a website including a Customer page in Manage Account for “Withdraw Funds” in accordance with an embodiment of the present invention. Under the “Withdraw Funds” tab or link, the Customer can withdraw funds from the Customer's account. In such cases, the Customer can withdraw funds by, but not limited to, check, PayPal®, bank wire, etc.

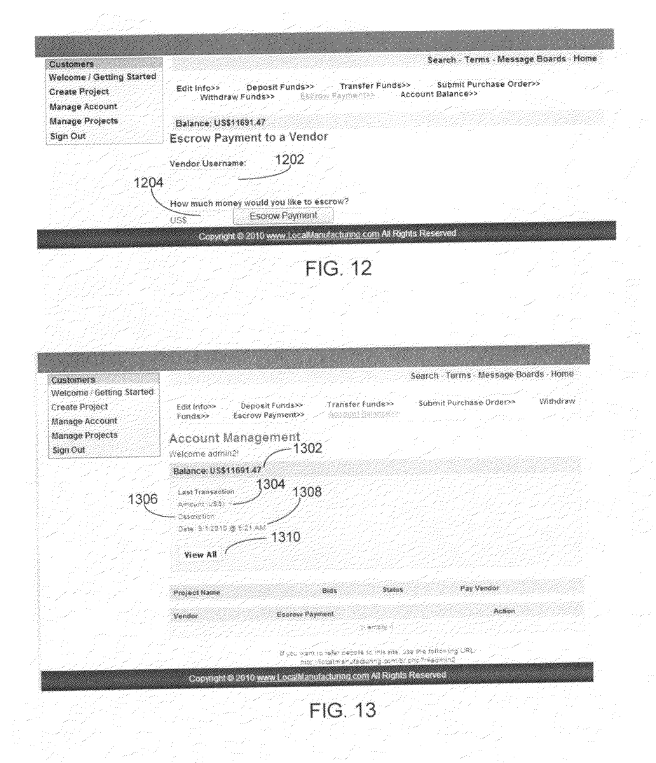

Referring now to FIG. 12, therein is a screenshot of an exemplary web page depicting a website including a Customer page in Manage Account for “Escrow Payment” in accordance with an embodiment of the present invention. Under the “Escrow Payment” tab or link, the Customer can fund a project, but also maintain control of those funds until a job has been completed and the Customer is ready to release the funds for payment to the Vendor. Generally, the escrow function works by allowing a Customer to place money, funds, or other property into the hands of a third person, to be held by the latter until the happening of a contingency or performance of a condition (e.g., completion of the Customer's project), and then delivered by the third party to the Vendor.

The Customer escrows payment by entering the Vendors Username in a Vendor Username field 1202 and the amount in the field 1204.

Referring now to FIG. 13, therein is a screenshot of an exemplary web page depicting a website including a Customer page in Manage Account for “Account Balance” in accordance with an embodiment of the present invention. Under the “Account Balance” tab or link, the Customer can view their current account balance 1302 along with their last transaction amount 1304, description 1306, and/or date of the last transaction 1308. Additionally, a “View All” tab, button or indicator 1310 can allow the Customer to view all of their account transactions.

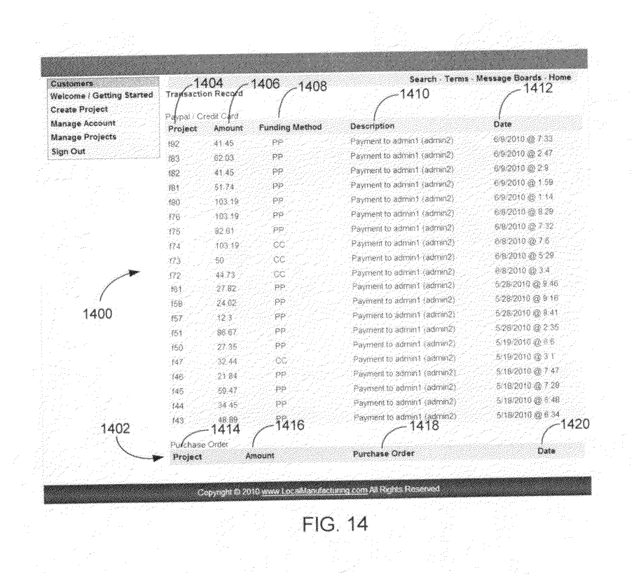

Referring now to FIG. 14, therein is a screenshot of an exemplary web page depicting a website including a Customer page in Manage Account for the “View All” button in “Account Balance” in accordance with an embodiment of the present invention. Under the “Account Balance” web page or link, if the Customer selects the “View All” button, the Customer can view all financial transactions for their projects. After selecting the “View All” button, a new web page or window can appear listing a transaction record of all the Customer's projects via a first table 1400 (e.g., a table including PayPal® and/or credit card transactions) and/or a second table 1402 (e.g., a table including escrow transactions). Generally, the first table may include, but is not limited to, a project name column 1404, a currency amount column 1406, a funding method column 1408, a description column 1410, and/or a date column 1412; and the second table 1402 may include, but is not limited to, a project name column 1414, a currency amount column 1416, a purchase order column 1418, and/or a date column 1420.

By way of example, the first table may list a transaction record of all the Customer's projects that have been accepted by the Customer and are awaiting payment to the Vendor from the finance group (e.g., a third-party vendor such as PayPal® or a credit card). In at least one embodiment, the Customer can select a “Pay Vendor” button, which will prompt the finance manager of the Company Website for a payment method. When a payment method has been selected, an electronic notification can be sent to the Company and/or the website server (e.g., such as the server 206, of FIG. 2) indicating that a payment is pending. Once the payment has been added to the Company or website escrow account, a final payment can be made to the Vendor and the project can be moved from the Customer “Manage Account” area to the Customer “Completed Projects” folder, web page, and/or link in the “Manage Projects” area.

By way of example, the second table may list a transaction record of all the Customer's projects that are funded using payment through the finance section (e.g., via the escrow option or the purchase order option). Generally, when the Customer accepts the product or manufactured good from the Vendor this releases the funding for the project to be paid to the Vendor. Additionally, upon acceptance by the Customer of the product or manufactured good, an electronic notification can be sent to the Company and/or the website server indicating that payment has transpired. Once the funds have been released to the Vendor, the project can be moved from the Customer “Manage Account” area to the Customer “Completed Projects” folder, web page, and/or link in the “Manage Projects” area.

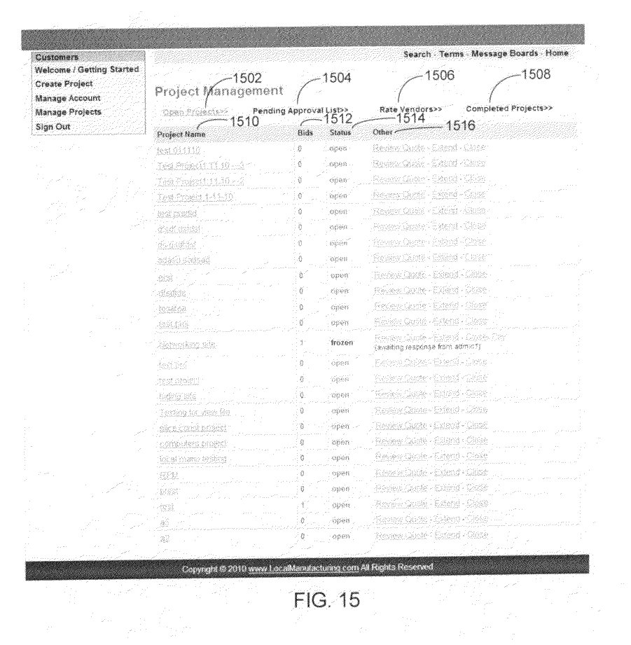

Referring now to FIG. 15, therein is shown a screenshot of an exemplary web page depicting a website including a Customer page for “Open Projects” under the “Manage Projects” link in accordance with an embodiment of the present invention. The web page(s) associated with the Customer “Manage Projects” link provide an area for managing and/or monitoring Customer projects associated with the website. From the “Manage Projects” web page, a Customer may, but is not limited to, view open projects 1502, view a pending approval list 1504, rate Vendors 1506, and/or view a completed projects list 1508.

Under the “Open Projects” tab or link 1502, the Customer can see each of their projects they have created and manage each of the projects after creation through to delivery and acceptance. The “Open Projects” tab or link 1502 may include, but is not limited to, a table listing the following columns or elements: “project name” 1510 (e.g., the name that was input by the Customer when the project was created), “bids” 1512 (e.g., the number of bids received on this project posting from Vendors capable of completing the project), “status” 1514 (e.g., an indicator of the state, condition or phase that the project is in), and/or “other” 1516 (e.g., project management functions).

By way of example, the “Status” column 1514 may include an indicator such as open, frozen, or working. Generally, the term “open” indicates that the project is still in the bidding phase, the term “frozen” indicates that the Customer has selected a Vendor to perform the work and that the Vendor has not yet accepted the work, and the term “working” indicates that the Vendor has accepted the project and is working to complete the project.

Additionally, by way of example, the “Other” column 1516 may include links such as, but not limited to, “Review Quote,” “Extend,” and/or “Close.”

In at least one embodiment, the “Review Quote” link may open to a new window or function that allows the Customer to review all quotes submitted for a specific project and to then select a Vendor for that project. This function can provide the Customer with the opportunity to select all of the work proposed or a portion of that work. An electronic notification can be sent to the chosen Vendor when the Customer decides who they want to perform their work. This electronic notification can indicate which work the Customer has selected for the Vendor to perform.

When a Vendor is selected, the Customer can be prompted to submit a form of payment for the project (e.g., PayPal®, credit card, or Vendor Terms (credit)). Generally, funds or monies will remain in an escrow account until the Customer has formally accepted the work and approved the release of those funds to the Vendor. In such cases wherein Vendor Terms are selected, prior approval will be required before initiating work.

Furthermore, in at least one embodiment, the “Extend” link may open to a new window or function that allows the delivery time for a project to be extended (e.g., via an electronic notification sent to the Vendor to notify them of the new delivery date when a project delivery date can be extended).

Furthermore, in at least one embodiment, the “Close” link may open to a new window or function that allows a project to be closed out and, thereby removing it from the “Open Projects” list.

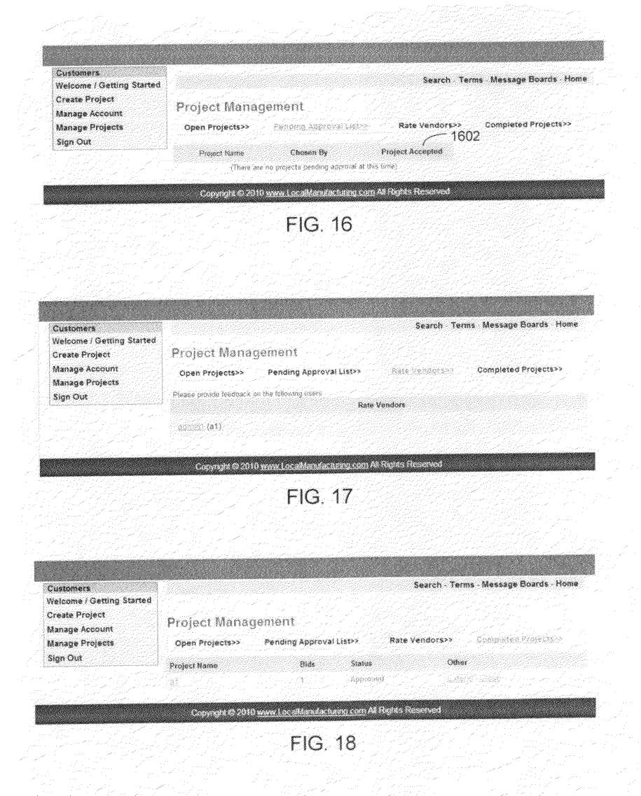

Referring now to FIG. 16, therein is shown a screenshot of an exemplary web page depicting a website including a Customer page for a “Pending Approval List” under the Customer “Manage Projects” link in accordance with an embodiment of the present invention. Under the “Pending Approval List” tab or link, the Customer can be notified of the completion of the project.

In at least one embodiment, the Vendor selected to complete the work for a specific project can notify the Customer that the project has been completed through the website. When this happens, an electronic notification can be sent to the Customer to notify them that the project is completed and waiting for their approval. At this time, the project can be moved to the “Pending Approval List.” The project can remain on the “Pending Approval List” until the Customer accepts or rejects the project.

By way of example, if the Customer accepts the project (e.g., by selecting the “Yes” button or indicator in the “Project Accepted” column 1602) a different action will occur depending on the funding method used to initiate the project. Generally, for PayPal® or credit card funded projects, accepting the work in the “Project Accepted” column 1602 notifies the Company or website to release the final payment to the Vendor. In at least one embodiment, this action can move the project to the “Completed Project” list or folder.

Generally, for “Vendor Terms” projects, accepting the work moves the project file into the “Manage Account” section so that the project can be paid using the accounting functions.

Additionally, by way of example, if the Customer rejects the project (e.g., by selecting the “No” button or indicator in the “Project Accepted” column 1602) an electronic notification can be sent to the Vendor notifying them that their work is not acceptable and that they need to contact the Customer to resolve pending issues.

Referring now to FIG. 17, therein is shown a screenshot of an exemplary web page depicting a website including a Customer page for “Rate Vendor” under the Customer “Manage Projects” link in accordance with an embodiment of the present invention. Under the “Rate Vendor” tab or link, the Customer can rate the performance of the Vendor on each job that is completed via a star rating system and/or a comment system, for example. In at least one embodiment, the star rating system may include five stars, wherein five (5) stars is the highest rating and one (1) star is the lowest rating. This rating system can provide an incentive to derive quality from all Vendors.

Referring now to FIG. 18, therein is shown a screenshot of an exemplary web page depicting a website including a Customer page for “Completed Projects” under the Customer “Manage Projects” link in accordance with an embodiment of the present invention. Under the “Completed Projects” tab or link, projects that are accepted can be moved to this list and can remain there until they are closed out on the website.

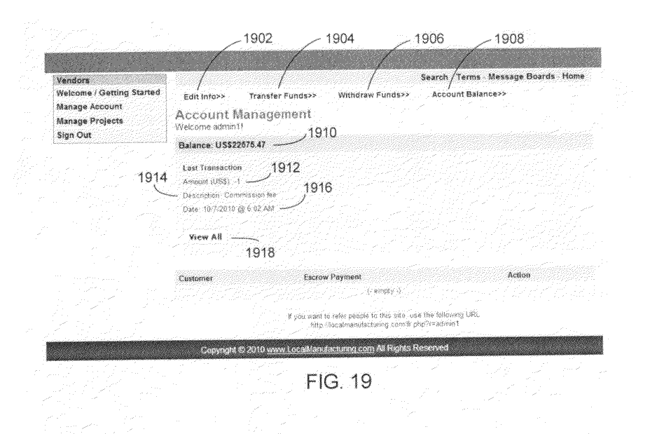

FIGS. 19-35 which follow, depict screenshots of exemplary web pages illustrating the Company Website from the Vendor side of the website, i.e., web pages as seen by the Vendor after logging-in to the website. It is to be understood that FIGS. 19-35 depict by way of example and not by limitation, exemplary Vendor web pages and they are not to be construed as limiting.

Referring now to FIG. 19, therein is shown a screenshot of an exemplary web page depicting a website including a Vendor page for the “Manage Account” link or window in accordance with an embodiment of the present invention. The web page(s) associated with the Vendor “Manage Account” link provide an area for managing Vendor financial transactions associated with the website. From the Vendor “Manage Account” or “Account Management” web page, a Vendor may, but is not limited to, edit their information 1902, transfer funds 1904, withdrawal funds 1906, and/or determine their account balance 1908.

In at least one embodiment, the “Manage Account” link may also include a current balance field 1910 and a last transaction amount field 1912, description field 1914, and/or a date field 1916. Additionally, a “View All” button, tab or indicator 1918 may also provide the Vendor with the option of viewing all projects.

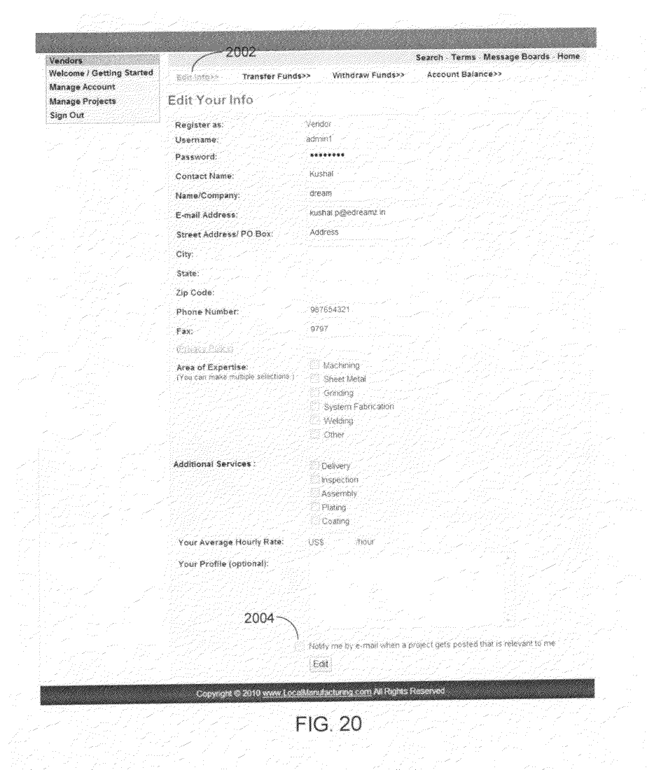

Referring now to FIG. 20, therein is shown a screenshot of an exemplary web page depicting a website including a Vendor page in Manage Account for the “Edit Info” link or window in accordance with an embodiment of the present invention. Under the “Edit Info” tab or link 2002, the Vendor can change their company information (e.g., username, password, contact name, name of company, email address, company address, phone, fax number, area of expertise, additional services, average hourly rate, and/or Vendor profile) so that their account can be current. In at least one embodiment, the “Edit Info” web page may include a check box 2004 that enables an electronic notification to be sent to the Vendor when a project is submitted to the website that is relevant to the Vendor. This feature allows the Vendor to be aware of the current bidding process without the need to continuously check their account. In other embodiments, this check box 2004 that enables electronic notification can also be located on other Vendor web pages, for example. In yet other embodiments, the “Edit Info” web page may also include a field, button or indicator for entering or selecting Vendor accreditations and/or qualifications (e.g., ISO 9002, Better Business Bureau, National Institute for Metalworking Skills (NMIS), etc.).

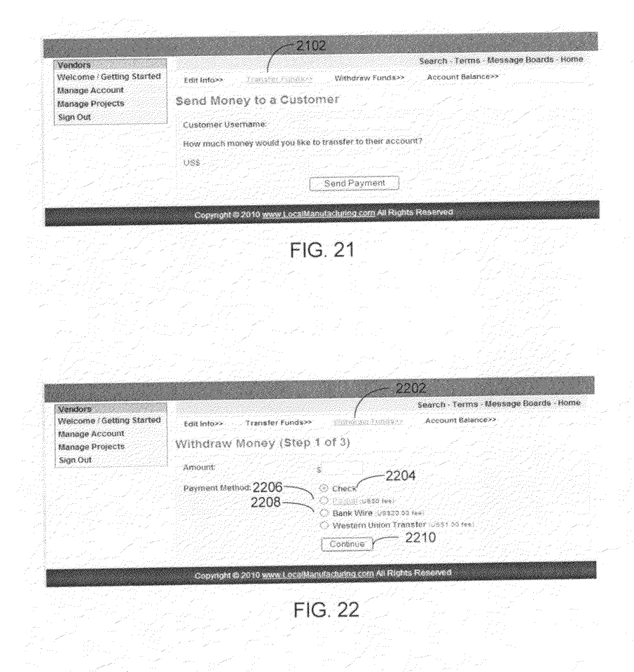

Referring now to FIG. 21, therein is shown a screenshot of an exemplary web page depicting a website including a Vendor page in Manage Account for the “Transfer Funds” link or window in accordance with an embodiment of the present invention. Under the “Transfer Funds” tab or link 2102, the Vendor can transfer funds or monies to the Customer. Generally, this function is only used for special cases (e.g., refunds).

Referring now to FIG. 22, therein is shown a screenshot of an exemplary web page depicting a website including a Vendor page in Manage Account for the “Withdraw Funds” link or window for step 1 of 3 in accordance with an embodiment of the present invention. Under the “Withdraw Funds” tab or link, the Vendor can withdraw funds from the Vendor's account. In such cases, the Vendor can withdraw funds by, but not limited to, check 2204, PayPal® 2206, bank wire 2208, etc. After filling in at least the required data fields, the Vendor can click on the “Continue” button, tab, or indicator 2210.

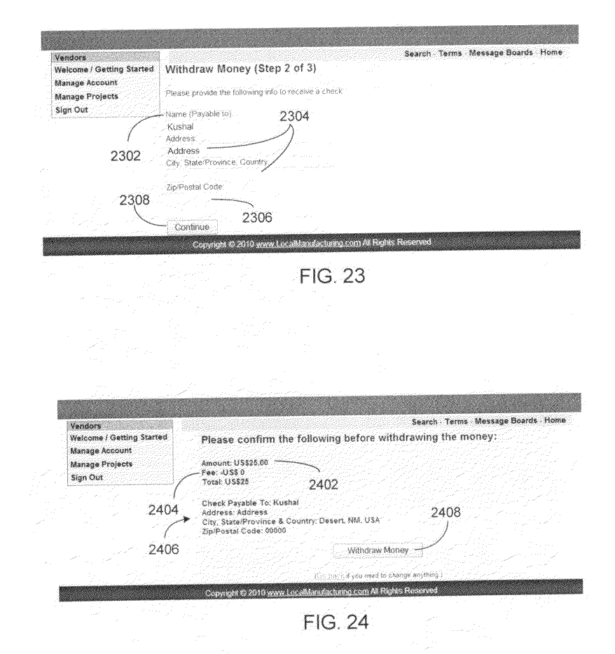

Referring now to FIG. 23, therein is shown a screenshot of an exemplary web page depicting a website including a Vendor page in Manage Account for the “Withdraw Funds” link or window for step 2 of 3 in accordance with an embodiment of the present invention. In at least one embodiment, the current web page may include a pay to field 2302 (e.g., the name of the Vendor), an address field 2304, and/or a zip code field 2306. After filling in at least the required data fields, the Vendor can click on the “Continue” button, tab, or indicator 2308.

Referring now to FIG. 24, therein is shown a screenshot of an exemplary web page depicting a website including a Vendor page in Manage Account for the “Withdraw Funds” link or window for step 3 of 3 in accordance with an embodiment of the present invention. In at least one embodiment, the current web page may require the Vendor to verify the amount of money to be withdrawn in a field 2402, the amount of fees charged in a field 2404, and/or the payee and the payee's address in a field 2406. After verifying the data fields, the Vendor can click on the “Withdraw Money” button, tab, or indicator 2408 to complete the transaction.

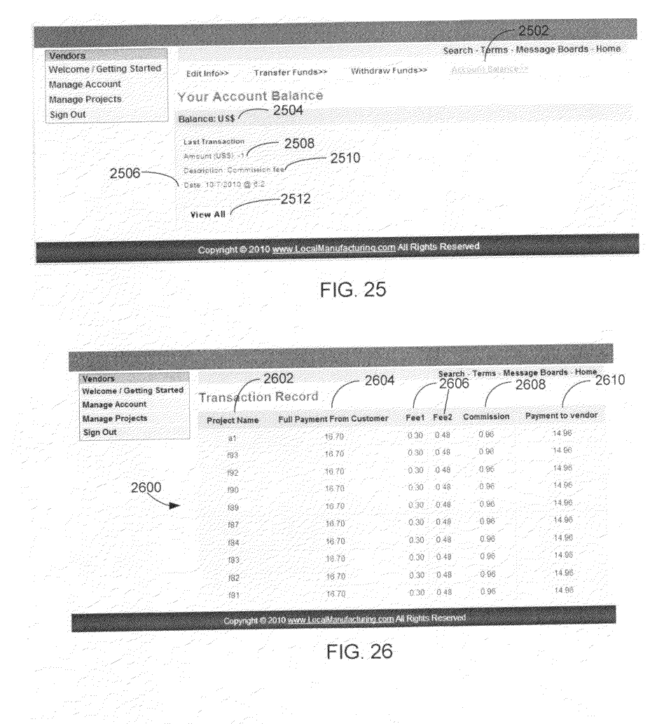

Referring now to FIG. 25, therein is shown a screenshot of an exemplary web page depicting a website including a Vendor page in Manage Account for the “Account Balance” link or window in accordance with an embodiment of the present invention. Under the “Account Balance” tab or link 2502, the Vendor can view their current account balance 2504 and their last transaction date 2506, amount 2508, and/or description of the transaction 2510. Additionally, a “View All” tab, button, or indicator 2512 can allow the Vendor to view all of their account transactions.

Referring now to FIG. 26, therein is shown a screenshot of an exemplary web page depicting a website including a Vendor page in Manage Account for the “View All” link or window under the “Account Balance” web page or link in accordance with an embodiment of the present invention. If the Vendor selects the “View All” button, the Vendor can view all financial transactions for their projects. After selecting the “View All” button, a new web page or window can appear listing a “Transaction Record” of all the Vendor's projects via a table 2600, for example. Generally, the table may include, but is not limited to, a “Project Name” column 2602, a “Full Payment From Customer” column 2604, one or more “Fee” column 2606, a “Commission” column 2608, and/or a “Payment to Vendor” column 2610.

By way of example, the “Project Name” column 2602 may be the name that was input by the Customer when the project was created; the “Full Payment From Customer” column 2604 may be the total monies paid by the Customer to the Vendor for the particular project; the one or more “Fee” column 2606 may represent monies owed by either the Vendor or the Customer for taxes, PayPal® fees, and/or additional services (e.g., delivery, inspection, etc.); the “Commission” column 2608 may represent the monies owed for using the service offered by the Company or website; and the “Payment to Vendor” column 2610 may represent the monies paid to the Vendor subsequent to subtracting the one or more “Fee” column 2606 and the “Commission” column 2608 from the “Full Payment From Customer” column 2604.

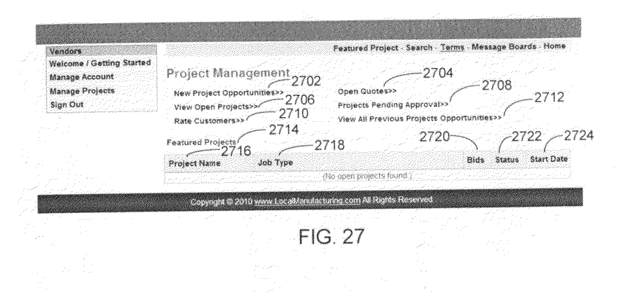

Referring now to FIG. 27, therein is shown a screenshot of an exemplary web page depicting a website including a Vendor page for the “Manage Projects” link or window in accordance with an embodiment of the present invention. The web page(s) associated with the Vendor “Manage Projects” link can provide an area for managing financial transactions associated with the website from quoting through to completion. From the Vendor “Manage Projects” web page, a Vendor may, but is not limited to, view “New Project Opportunities” 2702, view “Open Quotes” 2704, view “Open Projects” 2706, view “Projects Pending Approval” 2708, view “Rate Customers” 2710, and/or view “All Previous Project Opportunities” 2712.

Additionally, the “Manage Projects” web page may also include a “Featured Projects” listing 2714 at the bottom of the web page. The “Featured Projects” listing 2714 may include one or more descriptors, such as but not limited to, a “Project Name” column 2716 (e.g., the Customer name given to the project), a “Job Type” column 2718 (e.g., machining, grinding, welding, sheet metal, etc.), a “Bids” column 2720 (e.g., the number of bids received on this project posting from Vendors capable of completing the project), a “Status” column 2722 (e.g., open, frozen or closed), and/or a “Start Date” column 2724 (e.g., the date work can begin on the project).

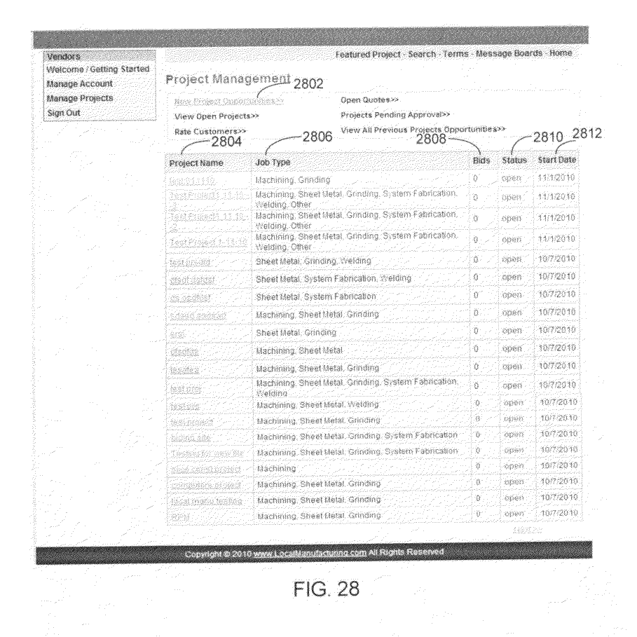

Referring now to FIG. 28, therein is shown a screenshot of an exemplary web page depicting a website including a Vendor page in Manage Projects for the “New Project Opportunities” link or window in accordance with an embodiment of the present invention. In at least one embodiment, the “New Project Opportunities” tab or link 2802 can provide a complete listing of all projects available for the Vendor to quote on through the website. The “New Project Opportunities” listing may include one or more descriptors, such as but not limited to, a “Project Name” column 2804 (e.g., the Customer name given to the project), a “Job Type” column 2806 (e.g., machining, grinding, welding, sheet metal, etc.), a “Bids” column 2808 (e.g., the number of bids received on this project's postings from Vendors capable of completing the project), a “Status” column 2810 (e.g., open, frozen or closed), and/or a “Start Date” column 2812 (e.g., the date work can begin on the project).

If the Vendor wishes to submit a bid for a particular project, the Vendor can select the project from the “Project Name” column 2804. Subsequent to selecting a particular project, the project name can link to a new window wherein additional details about the project request can be determined.

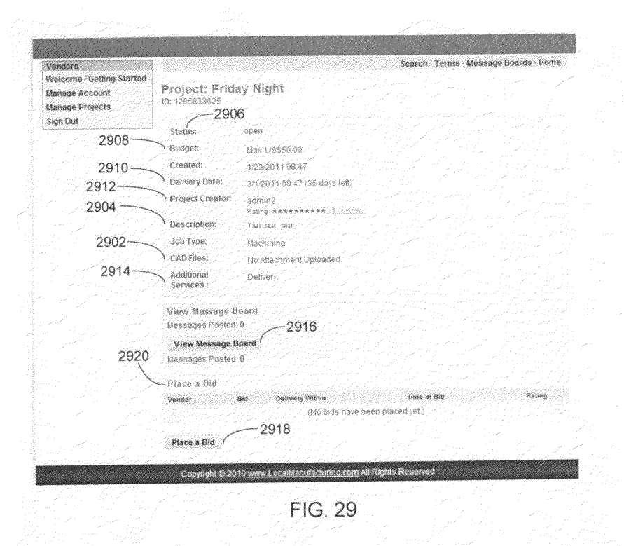

Referring now to FIG. 29, therein is shown a screenshot of an exemplary web page depicting a website including a Vendor page in Manage Projects for a particular “Project Name” in the “New Project Opportunities” link or window in accordance with an embodiment of the present invention. In at least one embodiment, the additional details can include a design drawings field 2902, a description field 2904, a status field 2906, a budget field 2908, a delivery date field 2910, a project creator field 2912, and/or an additional services field 2914.

In another embodiment, if the Vendor has any questions regarding the Customer's project, they can be submitted to the Customer via a Message Board tab, button or indicator 2916 provided by the website. This Message Board function can be a link provided on all web pages or on selected web pages.

If the Vendor determines that they wish to submit a bid for the project, they can prepare a bid off-line and then submit their bid via the website's “Place a Bid” tab, button, or indicator 2918 located on the selected project name window in the “Place a Bid” field 2920.

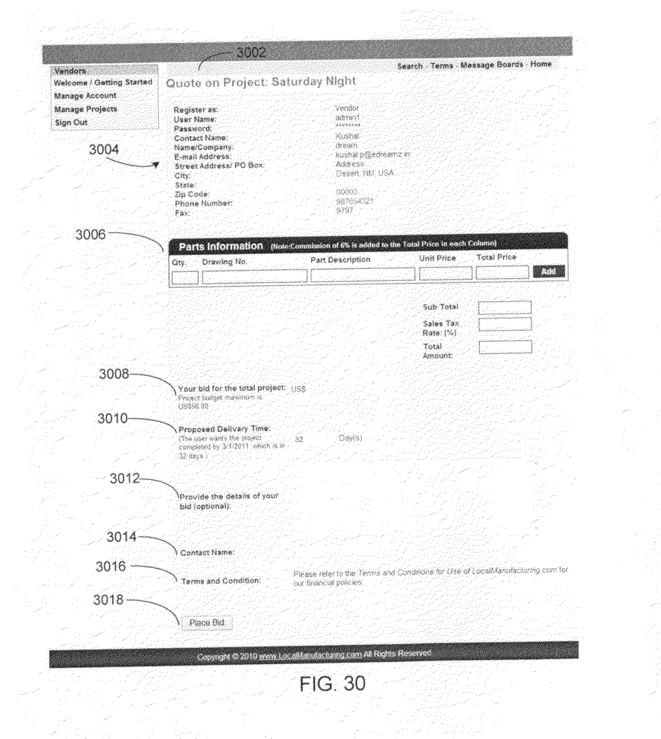

Referring now to FIG. 30, therein is shown a screenshot of an exemplary web page depicting a website including a Vendor page in Manage Projects for a particular “Quote on Project: Project Name” 3002 link or window from the “Place a Bid” button, tab, or indicator 2918, of FIG. 29, in accordance with an embodiment of the present invention. In at least one embodiment, the “Quote on Project: Project Name” 3002 link or window can include a Vendor information field 3004, a parts information field 3006, a bid for the total project field 3008, a delivery time field 3010, a details field 3012, a contact name field 3014, a terms and conditions field 3016, and/or a “Place Bid” button, tab or indicator 3018.

Generally, the parts information field 3006 may include additional fields for entry of data about the quantity, drawing number, part description, unit price, and/or total price. In at least one embodiment, the total price can be adjusted to not only reflect the cost of the goods or parts, but also to reflect the addition of a commission. For example, and not by way of limitation, if the Vendor were to provide five (5) parts at a unit price of twenty ($20) US dollars at a six (6%) percent commission, then the total price would be one hundred ($100) US dollars plus a commission surcharge of six ($6) US dollars, for a total of one hundred six ($106) US dollars. Additionally, the current web page may also include a field for entering the applicable sales tax rate, so that it may be added to the “Total Amount” of the bid. It is to be understood that the above example is not limited to United States (US) currency and may include all other forms of currency or legal tender as authorized by law.

By way of explanation, the bid for the total project field 3008 may include the “Total Amount” bid by the Vendor as seen by the Customer, the delivery time field 3010 can provide the number of days until delivery of the project is required, a details field 3012 can provide the Vendor with a means for providing additional comment about the quote, a contact name field 3014 provides a contact person for the project, and the terms and conditions field 3016 can provide a link to the terms and conditions for use of the website. In at least one embodiment, the Vendor has already viewed and accepted the terms and conditions of the website upon registering with the website or Company.

After entering in at least the required data in the required fields, the Vendor may then select the “Place Bid” button, tab or indicator 3018 for submission of their bid. In such cases, the website can automatically generate an electronic communication that is sent to the Customer, the Company, and/or the Vendor notifying them of the new Vendor bid.

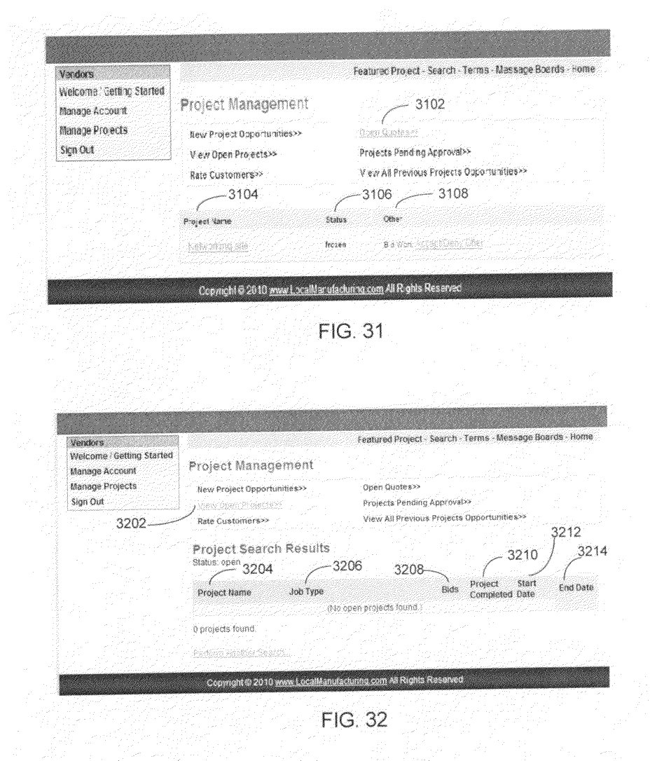

Referring now to FIG. 31, therein is shown a screenshot of an exemplary web page depicting a website including a Vendor page in Manage Accounts for the “Open Quotes” link or window in accordance with an embodiment of the present invention. This web page can allow the Vendor to review the status of all quoted projects. In at least one embodiment, the “Open Quotes” 3102 link or window can include a project name column 3104 (e.g., the name of the project provided by the Customer), a status column 3106, and/or an “Other” column 3108 to help in managing the Vendor's bids.

Generally, under the status column 3106, the project status options are Open, Pending, and/or Working. In such cases, an “Open” status can indicate that the Vendor bid is still being considered by the Customer. In at least one embodiment, the Vendor can retract their bid anytime while the project is in “Open” mode.

Generally, a “Pending” status can indicate that the Vendor bid has been selected and the Customer is waiting for the Vendor to accept or deny the project via the website or via an electronic communication.

Generally, a “Working” status can indicate that the Vendor is performing the work required to complete the project. In at least one embodiment, when a project is in the “Working” phase, a copy of the project may also appear under to the “View Open Projects” tab, button or indicator.

Additionally, under the “Other” column 3108 the Vendor may also accept or deny the offer of a bid won.

Referring now to FIG. 32, therein is shown a screenshot of an exemplary web page depicting a website including a Vendor page in Manage Projects for the “View Open Projects” link or window in accordance with an embodiment of the present invention. This web page can allow the Vendor to quickly see which projects they have open. In at least one embodiment, the “View Open Projects” 3202 link or window can include a project name column 3204 (e.g., the Customer name given to the project), a job type column 3206 (e.g., machining, grinding, welding, sheet metal, etc.), a bids column 3208 (e.g., the number of bids received on this project posting from Vendors capable of completing the project), a project completed column 3210, a start date column 3212 (e.g., the date work can begin on the project), and/or an end date column 3214 (e.g., the date work must be completed) to help in managing the Vendor's open projects.

Generally, once a project is completed, the Vendor may notify the Customer that the work is completed by selecting a “Notify” button, tab or indicator (not shown) for that project in the project completed column 3210. In an embodiment, this can change the project status indicator on the Customer side of the website as well. A copy of the project can be moved to the “Projects Pending Approval” list on both the Vendor and Customer sides of the website.

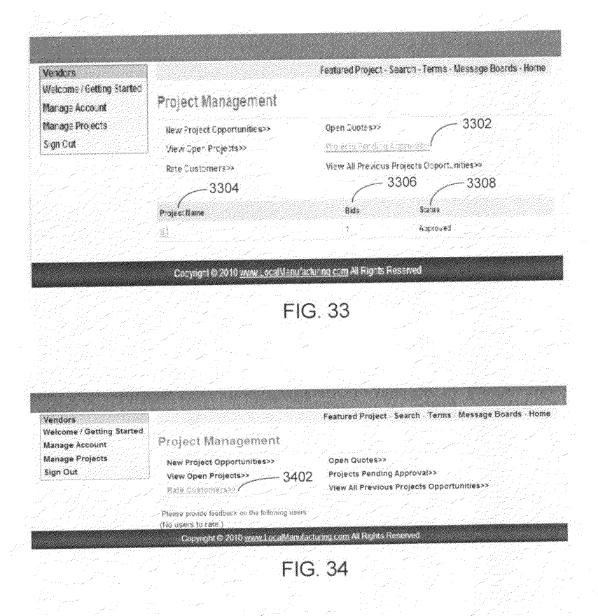

Referring now to FIG. 33, therein is shown a screenshot of an exemplary web page depicting a website including a Vendor page in Manage Projects for the “Projects Pending Approval” link or window in accordance with an embodiment of the present invention. This web page can allow the Vendor to quickly see which projects they have completed and are still pending approval from the Customer. In at least one embodiment, the “Projects Pending Approval” 3302 link or window can include a project name column 3304, a bids column 3306 (e.g., the number of bids received on this project posting from Vendors capable of completing the project), and/or a status column 3308 to help in managing the Vendor's projects which have been completed, but not yet paid for.

In at least one embodiment, when the Vendor notifies the Customer that the project has been completed an electronic notification can be sent to the customer to notify them that the project is completed and waiting for their approval. When this happens, the project can be moved to the Projects Pending Approval list, web page, link or window. The project will remain on the Projects Pending Approval List until the Customer either accepts or rejects the project.

Generally, if the Customer accepts the project by selecting the “Yes” function in the Project Accepted column, this action will move the project into the Customer's Manage Account section so that the project can be paid using the accounting functions. Correspondingly, if the Customer accepts the project, the status column 3308 can be automatically updated to show that the project has been “Approved.”

Generally, if the Customer rejects the project by selecting the “No” function in the Project Accepted column, this action generates an electronic communication notifying the Vendor that their work is not acceptable and that they need to contact the Customer to work out pending issues.

Referring now to FIG. 34, therein is shown a screenshot of an exemplary web page depicting a website including a Vendor page in Manage Projects for the “Rate Customer” link or window in accordance with an embodiment of the present invention. The “Rate Customer” link or window 3402 can allow the Vendor to rate the performance of the Customer on each job that is completed. After the Customer project has been completed and paid for, the Company Website may then solicit feedback from the Vendor about the Customer's performance and/or about ways to improve the overall process of the website. Such feedback, which may include a star rating system of the Customers' performance and/or a comments section, can provide a metric for future Vendors to base their decisions upon. By way of example, the star rating system may rate a Customer's accuracy of initial order, number of changes, payment history and/or overall professional ability.

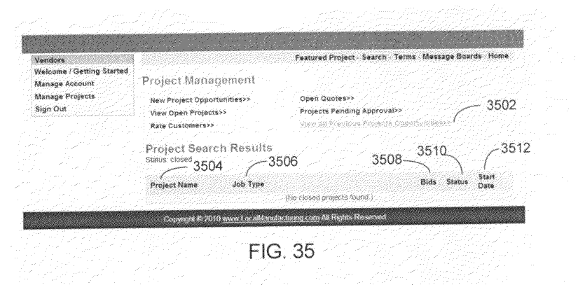

Referring now to FIG. 35, therein is shown a screenshot of an exemplary web page depicting a website including a Vendor page in Manage Projects for the “View All Previous Project Opportunities” link or window in accordance with an embodiment of the present invention. This web page can provide an archive of all previous projects available to bid on.

In at least one embodiment, the “View All Previous Project Opportunities” 3502 link or window can include a project name column 3504 (e.g., the Customer name given to the project), a job type column 3506 (e.g., machining, grinding, welding, sheet metal, etc.), a bids column 3508 (e.g., the number of bids received on this project posting from Vendors capable of completing the project), a status column 3510 (e.g., Open, Pending, or Working), and/or a start date column 3512 (e.g., the date work can begin on the project) to help in managing the Vendor's projects.

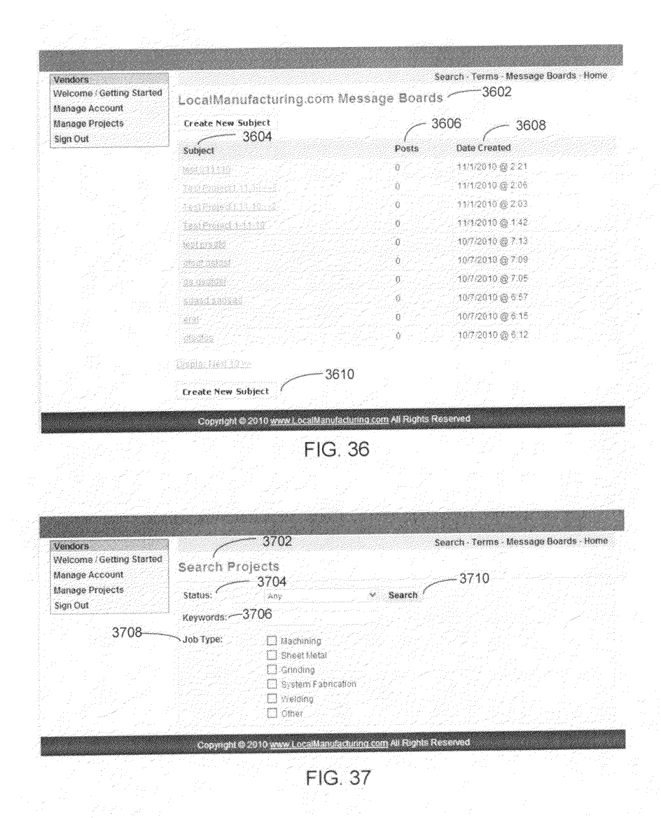

Referring now to FIG. 36, therein is shown a screenshot of an exemplary web page depicting a website including a Vendor page for the “Message Board” link or window in accordance with an embodiment of the present invention. However it is to be understood that the Customer side of the website may also include a Customer “Message Board” similar to the one described herein.

Generally, the Vendor “Message Board” web page can provide a list of all current and past postings of messages concerning a particular project. In at least one embodiment, the Vendor can only access projects that the particular Vendor has been awarded. In another embodiment, the Vendor can access all current projects posted on the website.

In at least one embodiment, the “Message Board” 3602 link or window can include a subject column 3604 (e.g., the Customer name given to the project or the project name), a posts column 3606 (e.g., the number of posts received concerning the project or subject), and/or a date created column 3608 (e.g., the date and time stamp of the post). Additionally, the “Message Board” 3602 link or window may also include a “Create New Subject” button, tab, or indicator 3610 so that a Vendor may create a new post.

Referring now to FIG. 37, therein is shown a screenshot of an exemplary web page depicting a website including a Vendor page for a “Search” link or window function in accordance with an embodiment of the present invention. However it is to be understood that the Customer side of the website may also include a Customer “Search” link or window function similar to the one described herein.

In at least one embodiment, the “Search Projects” 3702 link or window can include a status field 3704 (e.g., Open, Pending, or Working), a keywords field 3706 (e.g., for searching keywords of a project), and/or a job type field 3708 (e.g., for designating machining, sheet metal, grinding, system fabrication, welding, or other types of project). Additionally, the “Search Projects” 3702 link or window may also include a “Search” button, tab, or indicator 3710 so that a Vendor may query the database for the requested information.

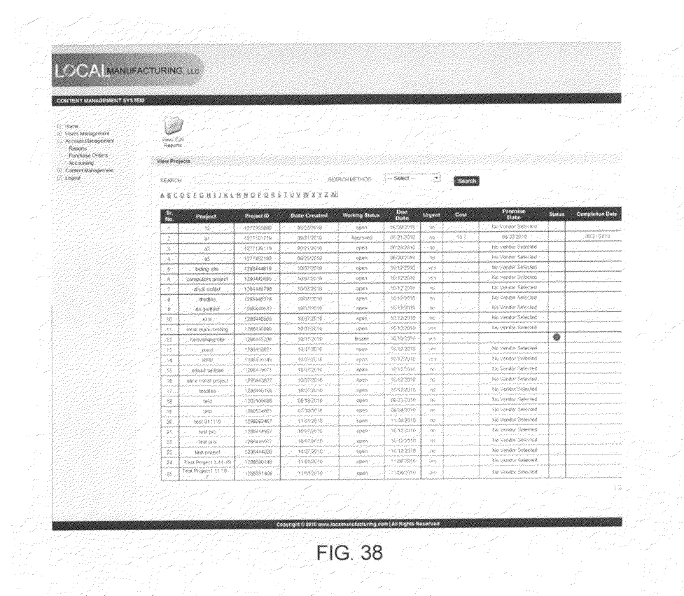

Referring now to FIG. 38, therein is shown a screenshot of an exemplary web page depicting a website including an administrative web page for a “Project Management” button, tab, or indicator under the reports section of the Account Management link or window function in accordance with an embodiment of the present invention. It will be appreciated by those skilled in the art that such a content management function can permit an administrative user of the website to perform maintenance, update, and/or generate reports about current, past and pending projects.

Accordingly, it has been discovered that the current embodiments described herein have numerous aspects. In at least one aspect, the current embodiments permit a method, system, or apparatus for obtaining competitive pricing on a bid request.

In another aspect, the current embodiments permit a method, system, or apparatus for obtaining quality Vendors for a build-to-order project because of a Vendor rating system based on Customer feedback.

In another aspect, the current embodiments permit a method, system, or apparatus for increasing the efficiency and reducing the overhead of a Customer by permitting a Customer to upload their build-to-order request to a single source point and receive multiple electronic bids or quotes for a project from a single posting.

In another aspect, the current embodiments permit a method, system, or apparatus for protecting local Vendors by utilizing a blind bid process and/or a local market pool where market rates are standardized.

In another aspect, the current embodiments permit a method, system, or apparatus for increasing sales volume and reducing marketing costs of a Vendor by providing free access to previously unknown job postings via a centralized service or website.

In another aspect, the current embodiments permit a method, system, or apparatus for increased efficiency by utilizing an electronic notification system (e.g., an email notification system) for new project postings on the website.

In another aspect, the current embodiments permit a method, system, or apparatus for improved efficiency and quality by utilizing private contact message boards for transferring information.

It has been discovered that the system, method and apparatus of the present embodiments provides a simplified system, method and apparatus that is effective, inexpensive, and efficient, thereby solving the earlier deficiencies of previous attempts within the art.

Having thus described in detail the exemplary embodiments of the invention, it is to be understood that the current embodiments defined by the appended claims is not to be limited by the particular details and the specific language set forth in the above description and that many apparent variations thereof are possible without departing from the scope of the invention. Accordingly, the above description and accompanying drawings are only illustrative of exemplary embodiments, which can achieve the principles, concepts, features and aspects of the present embodiments. It is not intended that the invention be limited to the embodiments shown and described in detail herein. The invention is only limited by the scope of the following claims.

What is claimed is:

1. A method comprising:
generating a request for quote for a custom part via a computer network system;
receiving one or more bids for the request for quote via a computer network system; and
accepting and paying an invoice for a bid acceptance via a computer network system.

2. The method as claimed in claim 1 wherein:
generating the request for quote includes uploading design files, choosing a job type, selecting additional services, designating one or more Vendors, or providing a due date.

3. The method as claimed in claim 1 further comprising:
authorizing acceptance of the bid via electronic notification.

4. The method as claimed in claim 1 further comprising:
receiving electronic updates on the status of the bid.

5. The method as claimed in claim 1 further comprising:
communicating about the bid via a message board.

6. The method as claimed in claim 1 wherein:
accepting and paying the invoice includes using a third party vendor.

7. A method comprising:
receiving a request for quote for a custom part via a computer network system;
generating one or more bids for the request for quote via a computer network system; and
generating an invoice for a bid acceptance via a computer network system.

8. The method as claimed in claim 7 further comprising:
generating electronic updates on the status of the bid.

9. The method as claimed in claim 7 further comprising:
communicating about the bid via a message board.

10. The method as claimed in claim 7 wherein:
generating one or more bids includes designating areas of expertise, additional services offered, and average hourly rate.

11. The method as claimed in claim 7 wherein:
generating an invoice for a bid acceptance includes sending electronic notice of completion of project.

12. The method as claimed in claim 7 further comprising:
receiving payment via the computer network system.

13. A method comprising:
receiving a request for quote for a custom part via a computer network system;
generating one or more bids for the request for quote via a computer network system; and
communicating completion and acceptance of custom part via a computer network system.

14. The method as claimed in claim 13 further comprising:
securing the computer network system.

15. The method as claimed in claim 13 further comprising:
storing data, files, programs, and/or web pages in a database.

16. The method as claimed in claim 13 wherein:
generating one or more bids includes generating a blind bid.

17. The method as claimed in claim 13 further comprising:
generating electronic updates about the request for quote and the bid.

18. The method as claimed in claim 13 further comprising:
monitoring the request for quote for a sufficient number of bids and for timeliness.

19. The method as claimed in claim 13 further comprising:
generating an electronic notice for pick-up or delivery of the custom part.

20. The method as claimed in claim 13 further comprising:
accepting and providing ratings of a Vendor and Customer.
